(19) United States
(12) Patent Application Publication
(10) Pub. No.: US 2019/0204082 A1
(43) Pub. Date: Jul. 4, 2019

(54) PHYSICAL QUANTITY SENSOR, METHOD OF MANUFACTURING PHYSICAL QUANTITY SENSOR, PHYSICAL QUANTITY SENSOR DEVICE, ELECTRONIC APPARATUS, AND VEHICLE

(71) Applicant: Seiko Epson Corporation, Tokyo (JP)

(72) Inventor: Shigekazu TAKAGI, Shiojiri (JP)

(21) Appl. No.: 16/227,245

(22) Filed: Dec. 20, 2018

(30) Foreign Application Priority Data
Dec. 28, 2017 (JP) 2017-254590

(51) Int. Cl. G01C 19/5769

(52) U.S. Cl. CPC G01C 19/5769

(57) ABSTRACT

A physical quantity sensor includes a substrate, a sensor element disposed on the substrate, and a conductor portion disposed on the substrate, and formed with the same material as that of the sensor element. In addition, the sensor element includes a moving structure that can be displaced with respect to the substrate, and a first fixed structure fixed on the substrate, and separated from the moving structure. In addition, the conductor portion includes a first conductor portion electrically connected to the moving structure and a second conductor portion disposed by being separated from the first conductor portion, and electrically connected to the first fixed structure. Accordingly, separated distance between the first conductor portion and the second conductor portion is smaller than a minimum gap in the sensor element.

The entire disclosure of Japanese Patent Application No. 2017-254590, filed Dec. 28, 2017 is expressly incorporated by reference herein.

### BACKGROUND

### 1. Technical Field

The present invention relates to a physical quantity sensor, a method of manufacturing a physical quantity sensor, a physical quantity sensor device, an electronic apparatus, and a vehicle.

### 2. Related Art

For example, an acceleration sensor described in JP-A-2013-140085 includes a substrate and sensor elements arranged on the substrate. In addition, the sensor element includes a fixed portion fixed on the substrate, a moving portion which is connected to the fixed portion via a spring and can be displaced on the substrate, a vehicle configured with a moving electrode finger provided on the moving portion, and a fixed electrode finger which is fixed on the substrate and arranged to be positioned to oppose the moving electrode finger. In such an acceleration sensor, when the moving portion is displaced to the substrate by applying acceleration, since a gap between the moving electrode finger and the fixed electrode finger changes and the electrostatic capacitance between the moving electrode finger and the fixed electrode finger changes, it is possible to detect acceleration based on the change of the electrostatic capacitance.

In addition, in JP-A-2013-140085, as a method of forming a sensor element, there is described a method of forming a conductive film on a silicon substrate, forming the sensor element by dry etching the silicon substrate in this state, and finally removing an unnecessary portion of the conductive film. With this configuration, until the sensor element is formed, each unit of the silicon substrate can be electrically connected by the conductive film. Therefore, unevenness of charges within the silicon substrate can be suppressed and each unit of the silicon substrate can be dry-etched uniformly. Accordingly, it is possible to form the sensor element with high processing accuracy.

However, in a method of forming a sensor element described in JP-A-2013-140085, after completing dry etching, it is necessary to remove some of the conductive films to separate the vehicle and the fixed electrode finger each other. Therefore, forming processes of the sensor element increase and the formation of the sensor element becomes complicated.

### SUMMARY

An advantage of some aspects of the invention is to provide a physical quantity sensor, a method of manufacturing a physical quantity sensor, a physical quantity sensor device, an electronic apparatus, and a vehicle capable of forming a sensor element with superior processing accuracy while suppressing the complication of the forming process.

The invention can be implemented as the following configurations.

A physical quantity sensor according to an aspect of the invention includes: a substrate; a sensor element disposed on the substrate; and a conductor portion disposed on the substrate, and formed with the same material as that of the sensor element, in which the sensor element includes a moving structure that can be displaced with respect to the substrate, and a first fixed structure fixed on the substrate, and separated from the moving structure, the conductor portion includes a first conductor portion electrically connected to the moving structure, and a second conductor portion disposed by being separated from the first conductor portion, and electrically connected to the first fixed structure, and separated distance between the first conductor portion and the second conductor portion is smaller than a minimum gap in the sensor element.

With this configuration, particularly, in a case where the sensor element is formed by the dry etching on a processing target substrate such as a silicon substrate, it is possible to suppress distribution of potential and heat within a processing target substrate (preferably, it is possible to uniformly process distribution), and it is possible to reduce etching unevenness within the processing target substrate. Therefore, it is possible to form the sensor element with high processing accuracy such that it is possible to obtain the physical quantity sensor that can detect physical quantity with high accuracy. Furthermore, as the above-described related art, since it is unnecessary to perform another process such as removal of a conductive film after the formation of the sensor element, it is possible to suppress the complication of the forming process of the sensor element.

In the physical quantity sensor according to the aspect of the invention, it is preferable that the sensor element includes a second fixed structure fixed on the substrate, and separated from the moving structure and the first fixed structure, the conductor portion includes a third conductor portion disposed by being separated from the first conductor portion and the second conductor portion, and electrically connected to the second fixed structure, and separated distance between the third conductor portion and a portion closer to the third conductor portion in the first conductor portion and the second conductor portion is smaller than the minimum gap in the sensor element.

With this configuration, particularly, in a case where the sensor element is formed by the dry etching on the processing target substrate such as the silicon substrate, it is possible to suppress distribution of potential and heat within the processing target substrate (preferable, it is possible to uniformly process distribution), and it is possible to reduce the etching unevenness within the processing target substrate. Therefore, it is possible to form the sensor element with high processing accuracy such that it is possible to obtain the physical quantity sensor which can detect the physical quantity with high accuracy.

In the physical quantity sensor according to the aspect of the invention, it is preferable that the moving structure includes a moving portion that can be displaced in a first direction with respect to the substrate, and a moving electrode finger provided on the moving portion, and formed with a longitudinal shape along a second direction intersecting the first direction, the first fixed structure includes a first fixed electrode finger formed with the longitudinal shape along the second direction, positioned at one side in the first direction with respect to the moving electrode finger, and positioned to oppose the moving electrode finger via a gap, and the second fixed structure includes a second fixed electrode finger formed with the longitudinal shape along the second direction, positioned at the other side in the first direction with respect to the moving electrode finger, and positioned to oppose the moving electrode finger via a gap.

With this configuration, the physical quantity sensor which can measure acceleration in the first direction is obtained. Therefore, the convenience of the physical quantity sensor is improved.

In the physical quantity sensor according to the aspect of the invention, it is preferable that the physical quantity sensor further includes a lid disposed on the substrate to cover the sensor element, in which the conductor portion is positioned outside the lid.

With this configuration, it is possible to use the conductor portion as a terminal.

In the physical quantity sensor according to the aspect of the invention, it is preferable that the main surface positioned to oppose the substrate of the sensor element and the main surface positioned to oppose the substrate of the conductor portion are positioned on the same surface.

With this configuration, from the height of the conductor portion, it is possible to know the height of the sensor element covered by the lid and cannot be visually observed.

In the physical quantity sensor according to the aspect of the invention, it is preferable that the physical quantity sensor further includes a first wire which is disposed on the substrate and electrically connects the moving structure and the first conductor portion each other and a second wire which is disposed on the substrate and electrically connects the first fixed structure and the second conductor portion each other are provided.

With this configuration, it is possible to electrically connect the moving structure and the first conductor portion with a simple configuration, and it is possible to electrically connect the first fixed structure and the second conductor portion with a simple configuration.

In the physical quantity sensor according to the aspect of the invention, it is preferable that the first wire includes a portion positioned between the substrate and the first conductor portion, and the second wire includes a portion positioned between the substrate and the second conductor portion.

With this configuration, it is possible to simply contact the first conductor portion and the first wire each other, and it is possible to simply contact the second conductor portion and the second wire each other. Accordingly, it is possible to more reliably perform electrical connection between the first and the second conductor portions and the first and the second wires.

In the physical quantity sensor according to the aspect of the invention, it is preferable that the substrate includes a first convex portion disposed by being overlapped with the first conductor portion, and a second convex portion disposed by being overlapped with the second conductor portion, the first wire is disposed by covering the first convex portion and in contact with the first conductor portion at a portion on the first convex portion, and the second wire is disposed by covering the second convex portion and in contact with the second conductor portion at a portion on the second convex portion.

As described above, without passing through other members, by being the first and the second wires directly in contact with the first and the second conductor portions, these electrical connections therebetween become favorable.

A method of manufacturing a physical quantity sensor according to an aspect of the invention includes: bonding a processing target substrate on a substrate; and etching the processing target to form a sensor element and a conductor portion from the processing target substrate, in which the sensor element includes a moving structure that can be displaced with respect to the substrate, and a first fixed structure fixed on the substrate, and separated from the moving structure, the conductor portion includes a first conductor portion electrically connected to the moving structure, and a second conductor portion disposed by being separated from the first conductor portion, and electrically connected to the first fixed structure, and in the etching, a time in which the first conductor portion and the second conductor portion are formed is later than a time in which the sensor element is formed.

With this configuration, it is possible to suppress distribution of potential and heat within the processing target substrate (preferably, it is possible to process distribution uniformly), and it is possible to reduce the etching unevenness within the processing target substrate. Therefore, it is possible to form the sensor element with high processing accuracy such that it is possible to obtain the physical quantity sensor which can detect physical quantity with high accuracy. Furthermore, as the above-described related art, since it is unnecessary to perform another process such as removal of a conductive film after the formation of the sensor element, it is possible to suppress the complication of the forming process of the sensor element.

In the method of manufacturing a physical quantity sensor according to the aspect of the invention, it is preferable that separated distance between the first conductor portion and the second conductor portion is smaller than a minimum gap in the sensor element.

With this configuration, more reliably, it is possible to reduce the etching unevenness within the processing target substrate.

Therefore, more reliably, it is possible to form the sensor element with high processing accuracy.

In the method of manufacturing a physical quantity sensor according to the aspect of the invention, it is preferable that the method of manufacturing a physical quantity sensor further includes removing the conductor portion after formation of the sensor element and the conductor portion.

With this configuration, it is possible to reduce a size of the physical quantity sensor.

A physical quantity sensor device according to an aspect of the invention includes: a physical quantity sensor, and a circuit element electrically connected to the physical quantity sensor.

With this configuration, it is possible to obtain the effect of the physical quantity sensor, and it is possible to obtain the physical quantity sensor device with high reliability.

An electronic apparatus according to an aspect of the invention includes: a physical quantity sensor, and a control unit that performs a control process based on a detection signal output from the physical quantity sensor.

With this configuration, it is possible to obtain the effect of the physical quantity sensor, and it is possible to obtain the electronic apparatus with high reliability.

A vehicle according to an aspect of the invention includes: a physical quantity sensor, and a control unit that performs a control process based on a detection signal output from the physical quantity sensor.

With this configuration, it is possible to obtain the effect of the physical quantity sensor, and it is possible to obtain the vehicle with high reliability.

### BRIEF DESCRIPTION OF THE DRAWINGS

The invention will be described with reference to the accompanying drawings, wherein like numbers reference like elements.

FIG. 1 is a plan view illustrating a physical quantity sensor according to a first embodiment.

FIG. 2 is a sectional view taken along line A-A in FIG. 1.

FIG. 3 is a sectional view taken along line B-B in FIG. 1.

FIG. 4 is a sectional view taken along line C-C in FIG. 1.

FIG. 5 is a plan view illustrating a modification example of a sensor element illustrated in FIG. 1.

FIG. 6 is a plan view illustrating another modification example of the sensor element illustrated in FIG. 1.

FIG. 7 is a diagram illustrating a voltage applied to the physical quantity sensor illustrated in FIG. 1.

FIG. 8 is a flowchart illustrating a manufacturing process of the physical quantity sensor illustrated in FIG. 1.

FIG. 9 is a plan view for explaining a method of manufacturing the physical quantity sensor.

FIG. 10 is a plan view for explaining the method of manufacturing a physical quantity sensor.

FIG. 11 is another plan view for explaining the method of manufacturing a physical quantity sensor.

FIG. 12 is a still another plan view for explaining the method of manufacturing a physical quantity sensor.

FIG. 13 is a further still another plan view for explaining the method of manufacturing a physical quantity sensor.

FIG. 14 is a sectional view taken along line D-D in FIG. 13.

FIG. 15 is a further still another plan view for explaining the method of manufacturing a physical quantity sensor.

FIG. 16 is a further still another plan view for explaining the method of manufacturing a physical quantity sensor.

FIG. 17 is a plan view illustrating a physical quantity sensor according to a second embodiment.

FIG. 18 is a plan view for explaining a method of manufacturing the physical quantity sensor illustrated in FIG. 17.

FIG. 19 is another plan view for explaining the method of manufacturing a physical quantity sensor illustrated in FIG. 17.

FIG. 20 is a sectional view illustrating a physical quantity sensor device according to a third embodiment.

FIG. 21 is a perspective view illustrating an electronic apparatus according to a fourth embodiment.

FIG. 22 is a perspective view illustrating an electronic apparatus according to a fifth embodiment.

FIG. 23 is a perspective view illustrating an electronic apparatus according to a sixth embodiment.

FIG. 24 is a perspective view illustrating a vehicle according to a seventh embodiment.

### DESCRIPTION OF EXEMPLARY EMBODIMENTS

Hereinafter, a physical quantity sensor, a method of manufacturing the physical quantity sensor, a physical quantity sensor device, an electronic apparatus, and a vehicle according to the invention will be described in detail based on an embodiment illustrated in the accompanying drawings.

### First Embodiment

First, the physical quantity sensor according to a first embodiment will be described.

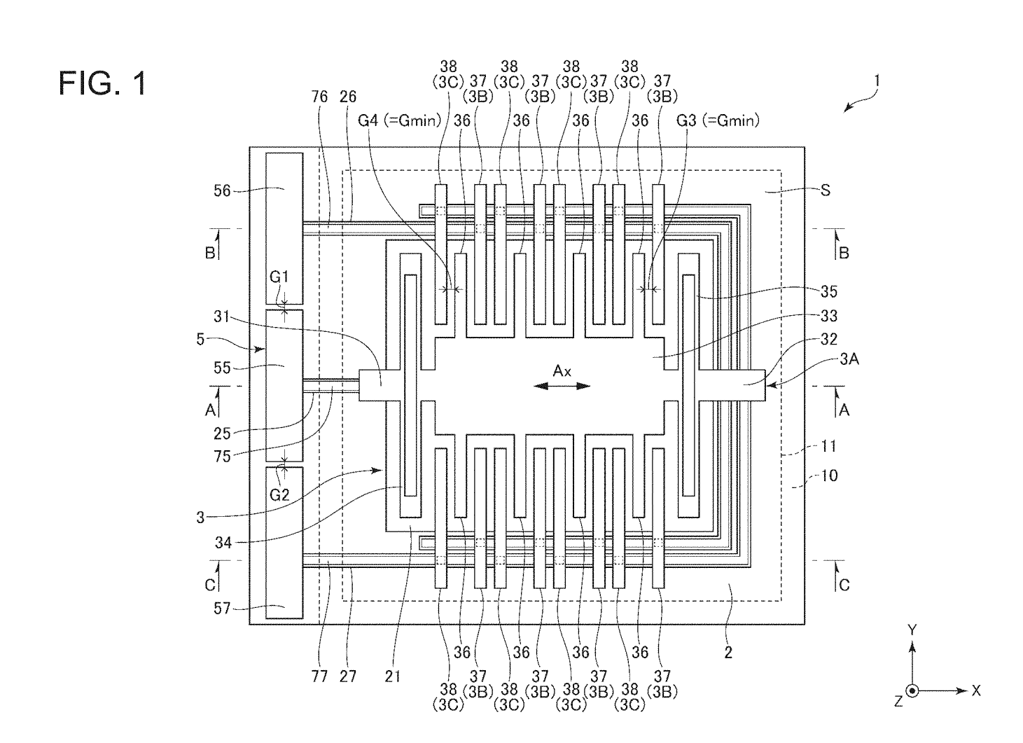

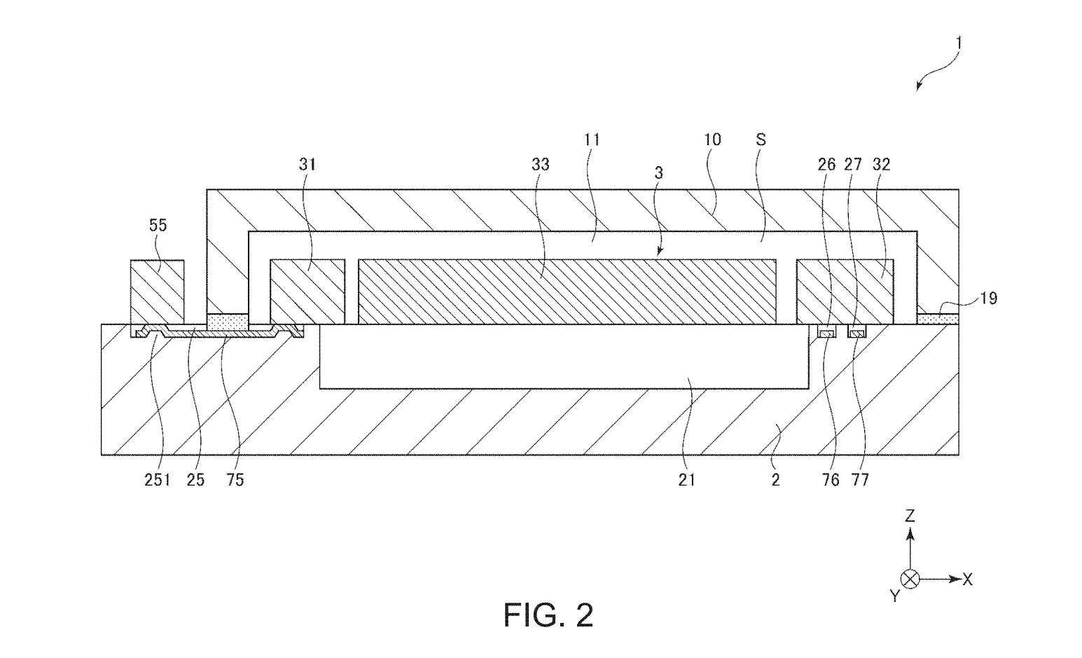

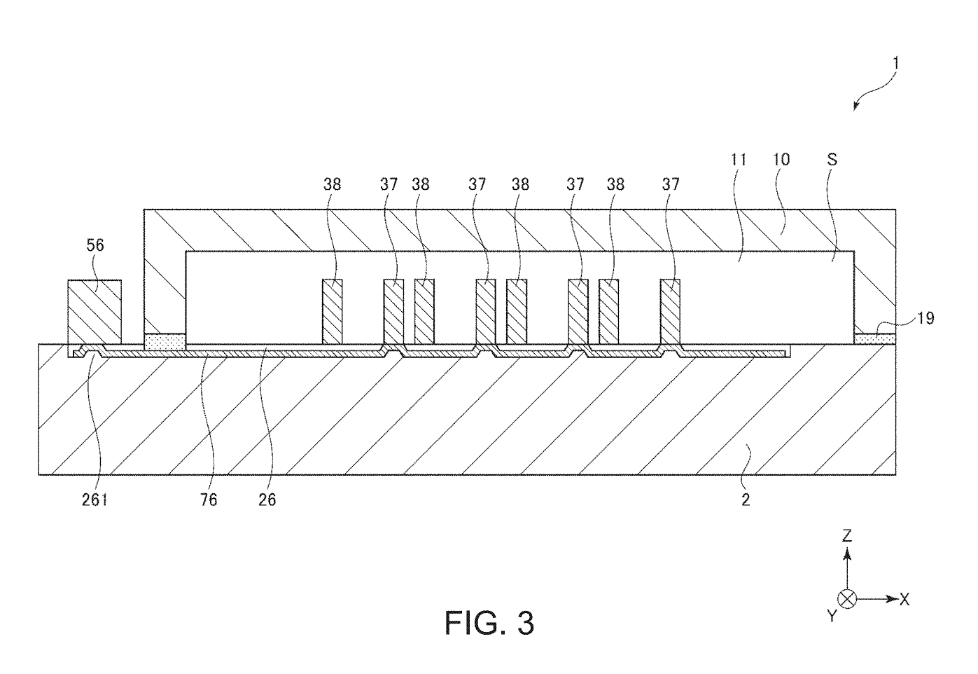

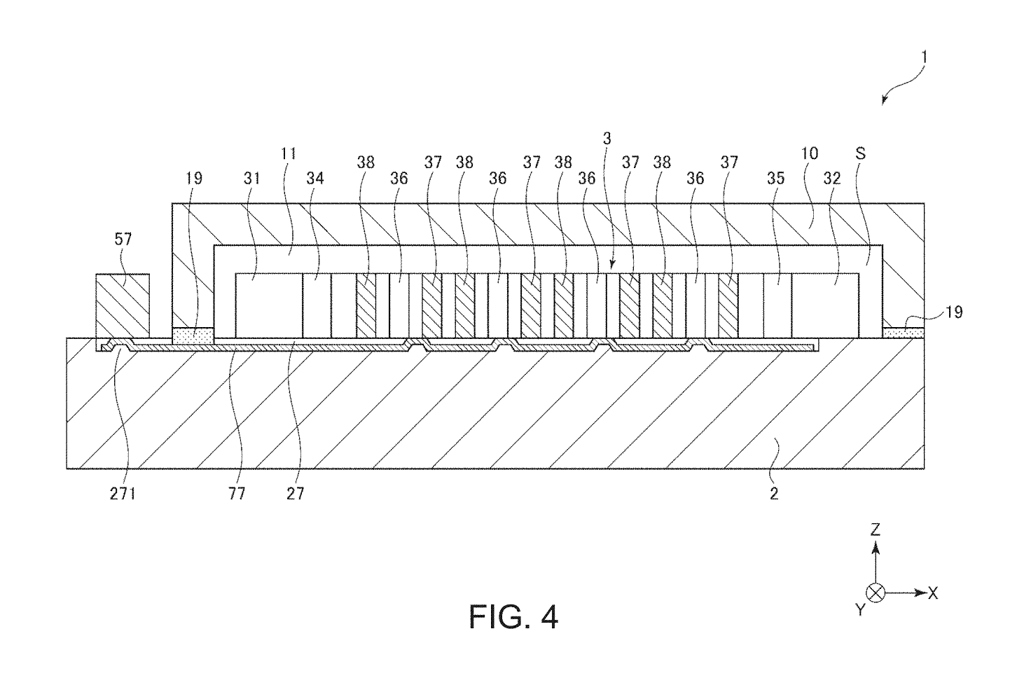

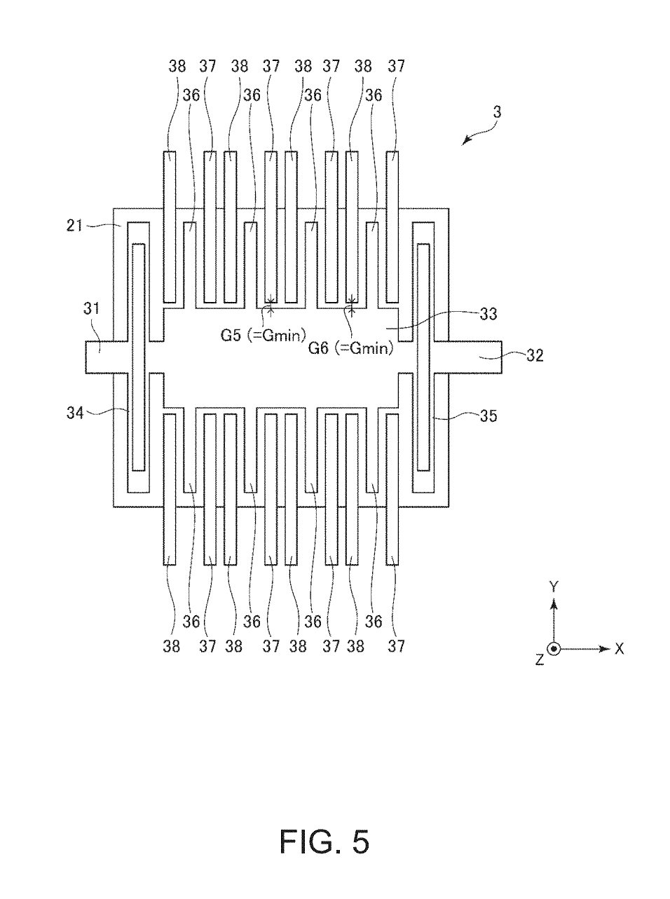

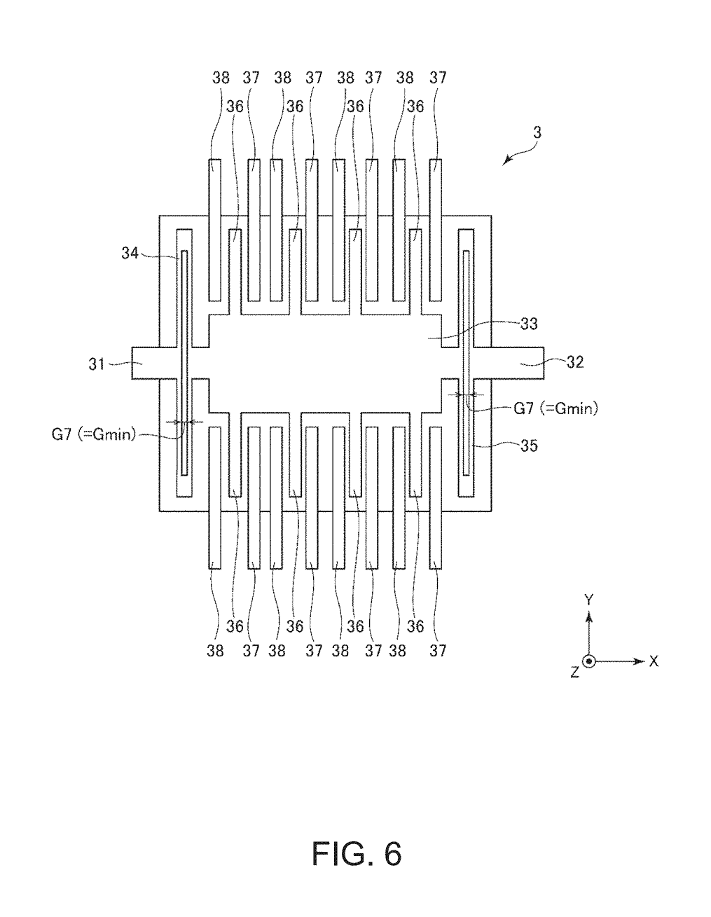

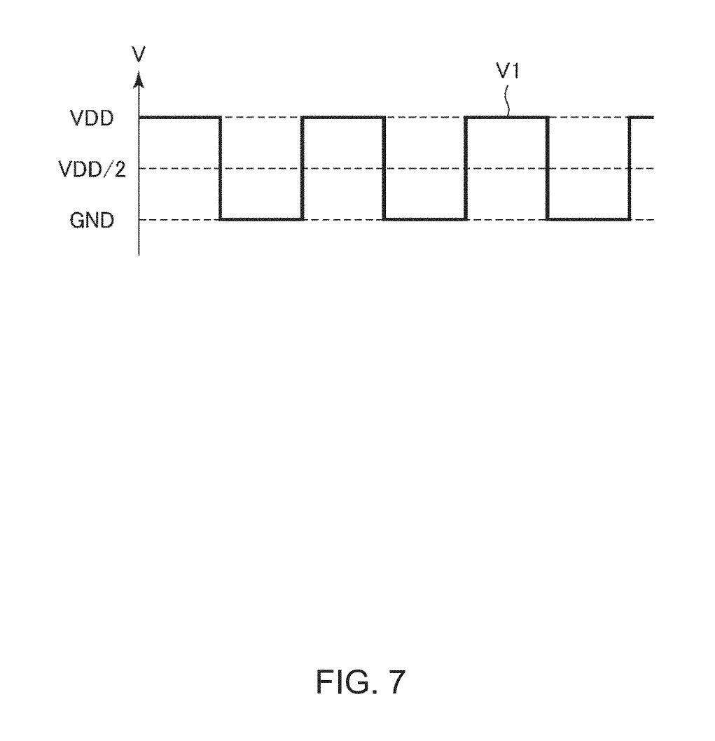

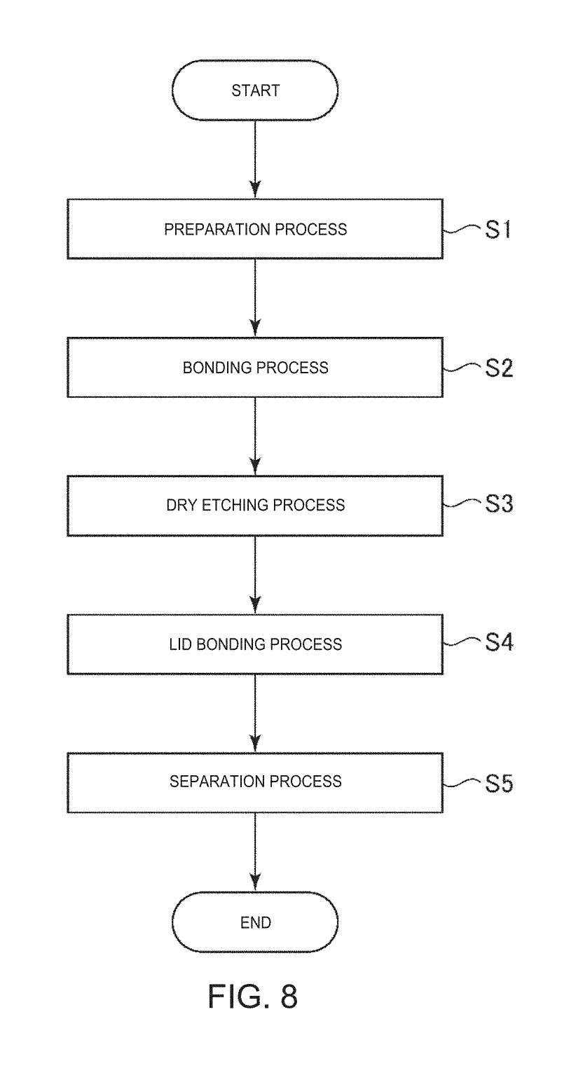

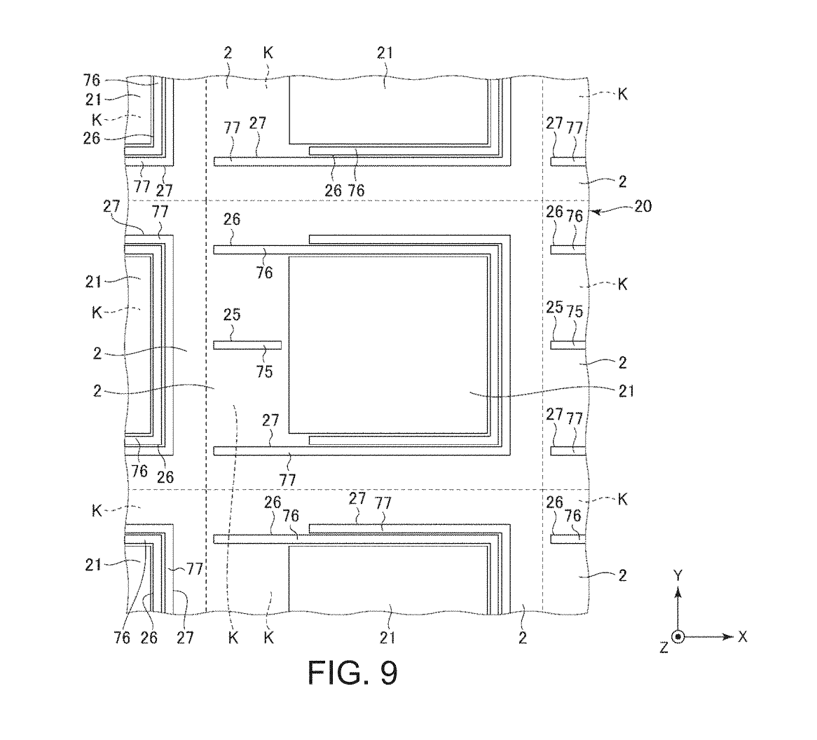

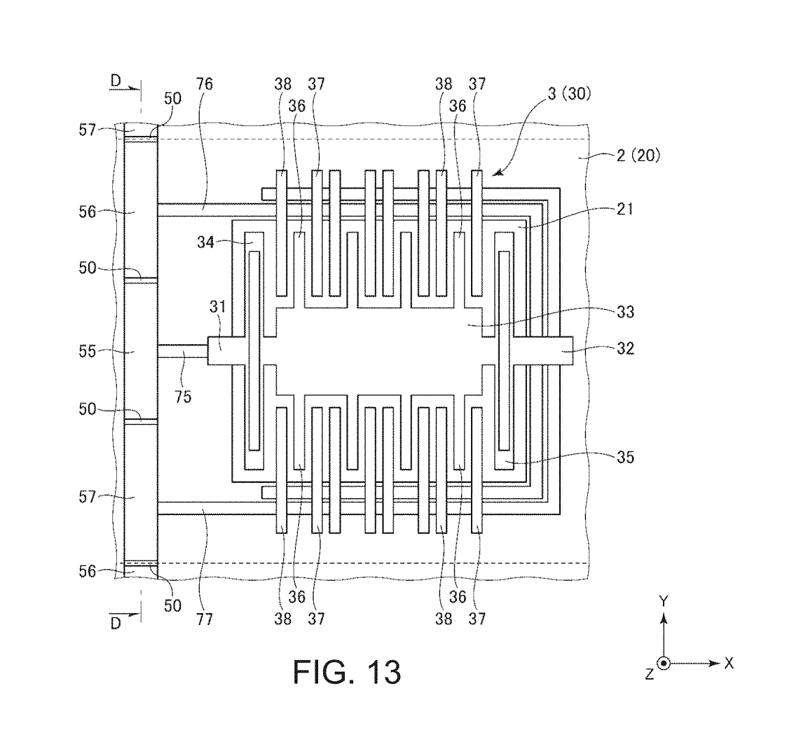

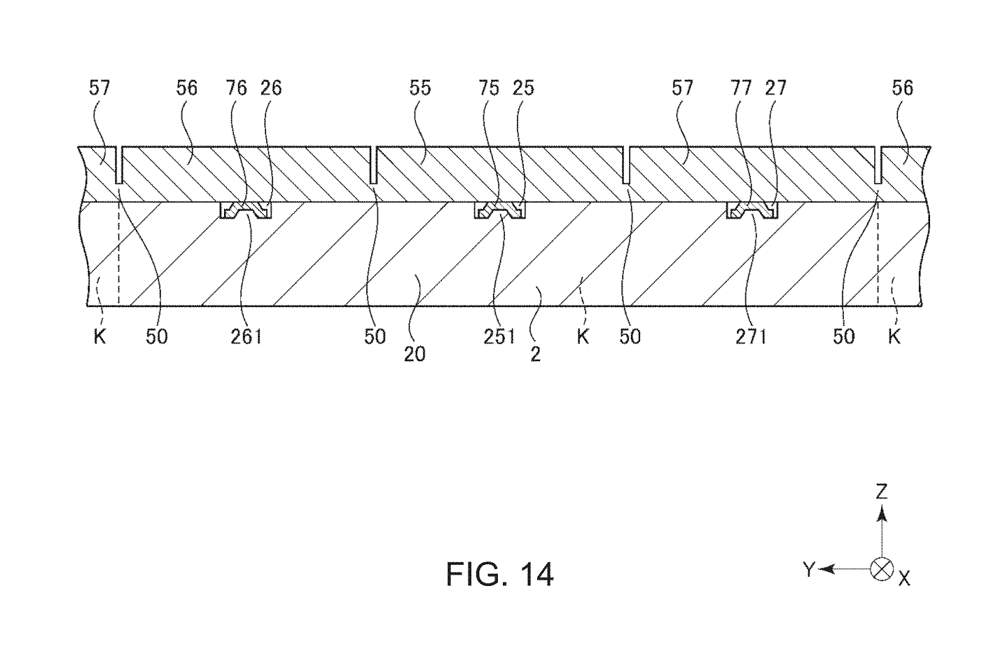

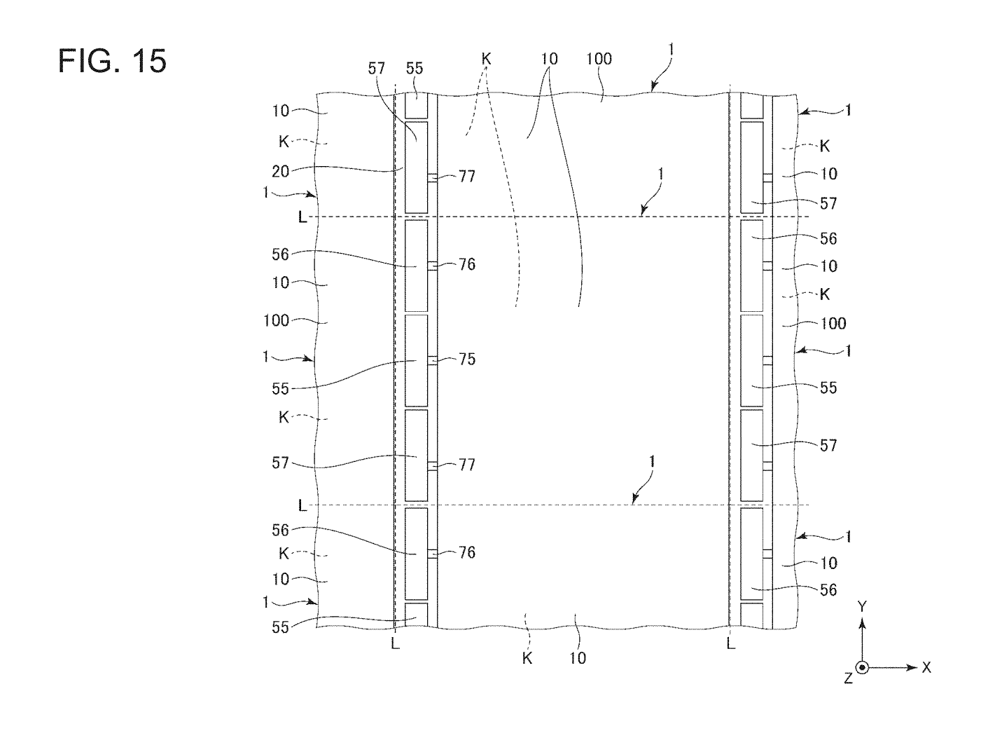

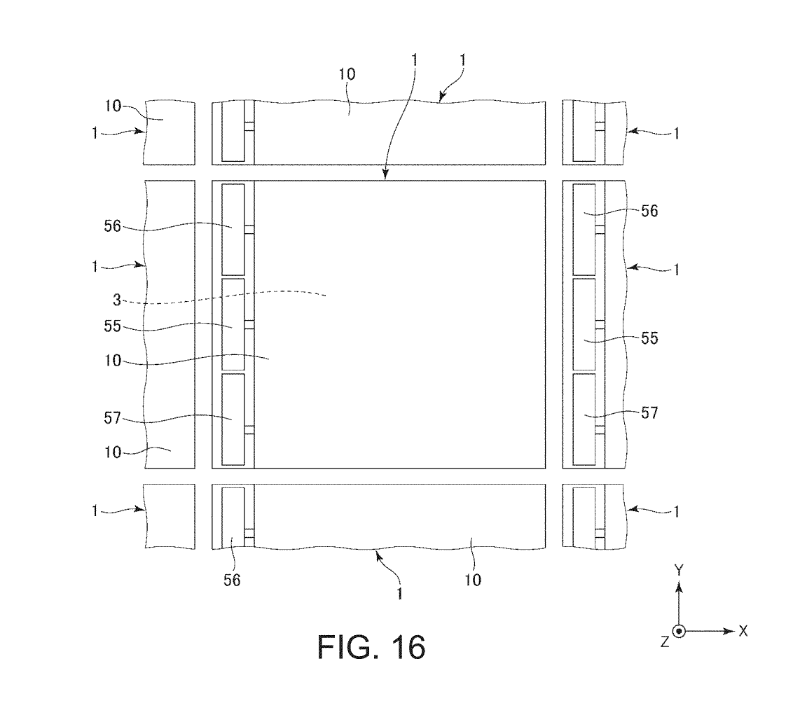

FIG. 1 is a plan view illustrating the physical quantity sensor according to the first embodiment. FIG. 2 is a sectional view taken along line A-A in FIG. 1. FIG. 3 is a sectional view taken along line B-B in FIG. 1. FIG. 4 is a sectional view taken along line C-C in FIG. 1. FIG. 5 and FIG. 6 are plan views illustrating modification examples of a sensor element illustrated in FIG. 1. FIG. 7 is a diagram illustrating a voltage applied to the physical quantity sensor illustrated in FIG. 1. FIG. 8 is a flowchart illustrating a manufacturing process of the physical quantity sensor illustrated in FIG. 1. FIG. 9 to FIG. 13 are plan views for explaining the method of manufacturing a physical quantity sensor. FIG. 14 is a sectional view taken along line D-D in FIG. 13. FIG. 15 and FIG. 16 are plan views for explaining the method of manufacturing a physical quantity sensor.

In the following, for convenience of explanation, three axes orthogonal to each other are defined as an X-axis, a Y-axis, and a Z-axis, a direction parallel to the X-axis is also referred to as an “X-axis direction”, a direction parallel to the Y axis is also referred to as an “Y-axis direction”, and a direction parallel to the Z-axis is also referred to as a “Z-axis direction”. In addition, a tip end side of each axis in an arrow direction is also called as a “plus side” and the opposite side is also called as a “minus side”. In addition, the plus side in the Z-axis direction is also referred to as “upper”, and the minus side in the Z-axis direction is also referred to as “lower”.

A physical quantity sensor 1 illustrated in FIG. 1 is an acceleration sensor which can detect acceleration Ax in the X-axis direction. The physical quantity sensor 1 includes a substrate 2, a sensor element 3 which is provided on the substrate 2 and detects the acceleration Ax (physical quantity) in the X-axis direction, a lid 10 bonded to the substrate 2 so as to cover the sensor element 3, and a conductor portion 5 which is provided on the substrate 2 and electrically connected to the sensor element 3.

As illustrated in FIG. 1, the substrate 2 includes a concave portion 21 of which an upper surface is open. In a plan view in the Z-axis direction, the concave portion 21 is formed by being overlapped with the sensor element 3. Such a concave portion 21 functions as a relief portion for reducing the possibility of contact between the sensor element 3 and the substrate 2. In addition, the substrate 2 includes grooves 25, 26, and 27 of which upper surfaces are open, and the wires 75, 76, and 77 are arranged in the grooves 25, 26, and 27.

Each of the wires 75, 76, and 77 are electrically connected to the sensor element 3. In addition, one end of each of the wires 75, 76, and 77 is exposed outside the lid 10, and electrically connected to the conductor portion 5 outside the lid 10. That is, each of the wires 75, 76, and 77 functions as the wire for electrically connecting the sensor element 3 and the conductor portion 5.

For example, as such a substrate 2, it is possible to use a glass substrate configured with a glass material (for example, borosilicate glass such as Pyrex glass, Tampax glass (registered trademark)) containing an alkali metal ion such as sodium ion. With this configuration, as described below, it is possible to bond the sensor element 3 and the substrate 2 by anodic bonding, and it is possible to bond them firmly. However, the substrate 2 is not limited to the glass substrate, for example, the silicon substrate and a ceramic substrate may be used. In a case where the silicon substrate is used, from the viewpoint of reducing the possibility of short circuit, the silicon substrate with high resistance is used, but it is preferable that a silicon substrate on which a silicon oxide film (insulating oxide) is formed by thermal oxidation or the like on a surface, is used.

As illustrated in FIG. 1, the lid 10 includes a concave portion 11 of which a lower surface side is open. Such a lid 10 is bonded to an upper surface of the substrate 2 to store the sensor element 3 within the concave portion 11. A storage space S for storing the sensor element 3 by the lid 10 and the substrate 2 is formed. An inert gas such as nitrogen, helium, argon, or the like is sealed in the storage space S and it is preferable that it is approximately 1/10 to 1 atmosphere pressure at a working temperature (approximately −40° C. to 120° C.). By setting the storage space S to approximately 1/10 to 1 atmosphere pressure, viscous resistance increases and a damping effect is exerted, and it is possible to promptly converge vibration of the sensor element 3. Therefore, the detection accuracy of the acceleration Ax of the physical quantity sensor 1 is improved.

Such a lid 10 is formed from the silicon substrate. However, the lid 10 is not limited to the silicon substrate. For example, the lid 10 may be formed from the glass substrate and the ceramic substrate. In addition, a method of bonding the substrate 2 and the lid 10 is not particularly limited, and the bonding method may be appropriately selected according to materials of the substrate 2 and the lid 10. However, for example, there are the anodic bonding, activation bonding for bonding the bonding surfaces activated by plasma irradiation, bonding with a bonding material such as glass frit, diffusion bonding for bonding the metal films formed on the upper surface of the substrate 2 and the lower surface of the lid 10, and the like. In the present embodiment, as illustrated in FIG. 2, the substrate 2 and the lid 10 are bonded with each other via a glass frit 19 (low melting point glass).

As illustrated in FIG. 1, the sensor element 3 is provided on the upper surface of the substrate 2. The sensor element 3 includes a moving structure 3A which can be displaced with respect to the substrate 2, a first fixed structure 3B fixed to the upper surface of the substrate 2, and a second fixed structure 3C. In addition, the moving structure 3A includes a pair of fixed portions 31 and 32 fixed to the upper surface of the substrate 2, a moving portion 33 disposed between the fixed portions 31 and 32, and positioned on the concave portion 21, a pair of springs 34 and 35 for connecting the moving portion 33 and the fixed portions 31 and 32, and a plurality of moving electrode fingers 36 protruding at both sides in the Y-axis direction from the moving portion 33. In such a moving structure 3A, by applying the acceleration Ax in the X-axis direction, the moving portion 33 is displaced in the X-axis direction while elastically deforming the springs 34 and 35.

Meanwhile, the first fixed structure 3B includes a plurality of first fixed electrode fingers 37 which are fixed to the upper surface of the substrate 2 and extend in the Y-axis direction, and the second fixed structure 3C includes a plurality of second fixed electrode fingers 38 which are fixed to the upper surface of the substrate 2 and extend in the Y-axis direction. Each first fixed electrode finger 37 is positioned to oppose a corresponding moving electrode finger 36 by being positioned at a plus side in the X-axis direction, and each second fixed electrode finger 38 is positioned to oppose a corresponding moving electrode finger 36 by being positioned at a minus side in the X-axis direction.

In other words, one moving electrode finger 36 is disposed between the first and the second fixed electrode fingers 37 and 38 of a set.

Accordingly, the moving structure 3A is electrically connected to the wire 75 in a fixed portion 31, each of the first fixed electrode fingers 37 is electrically connected to the wire 76, and each of the second fixed electrode fingers 38 is electrically connected to the wire 77.

For example, such a sensor element 3 can be formed by patterning using etching (particularly dry etching) on a conductive silicon substrate doped with impurities such as phosphorus (P), boron (B), arsenic (As), or the like. In addition, the sensor element 3 is bonded to the upper surface of the substrate 2 by the anodic bonding. However, the material of the sensor element 3 and a method of bonding the sensor element 3 and the substrate 2 are not particularly limited.

As illustrated in FIG. 1, the conductor portion 5 is disposed on the upper surface of the substrate 2 outside the lid 10. In addition, the conductor portion 5 includes a first conductor portion 55, a second conductor portion 56, and a third conductor portion 57. The first conductor portion 55, the second conductor portion 56, and the third conductor portion 57 are arranged by being separated from each other in parallel in the Y-axis direction. Specifically, the first conductor portion 55 is positioned at the center. Accordingly, the second conductor portion 56 is positioned via a gap G1 at a plus side of the first conductor portion 55 in the Y-axis direction, and the third conductor portion 57 is positioned via a gap G2 at a minus side of the first conductor portion 55 in the Y-axis direction. In addition, each of the first conductor portion 55, the second conductor portion 56, and the third conductor portion 57 is formed with the longitudinal shape (rectangular shape) along the Y-axis direction.

However, the arrangement and shape of the first conductor portion 55, the second conductor portion 56, and the third conductor portion 57 are not particularly limited. For example, the second conductor portion 56 or the third conductor portion 57 may be positioned at the center, and other two portions may be positioned at both sides.

As illustrated in FIG. 2, the first conductor portion 55 is disposed by being overlapped with the groove 25, and electrically connected to the wire 75 disposed in the groove 25. Specifically, a convex portion 251 protruding from the bottom surface is provided in a portion overlapped with the first conductor portion 55 of the groove 25, and the wire 75 is formed as a film to cover the convex portion 251. Accordingly, a portion positioned at the top surface of the convex portion 251 of the wire 75 is in contact with a lower surface of the first conductor portion 55, and the wire 75 and the first conductor portion 55 are electrically connected to each other.

In addition, as illustrated in FIG. 3, the second conductor portion 56 is disposed by being overlapped with the groove 26, and electrically connected to the wire 76 disposed in the groove 26. Specifically, a convex portion 261 protruding from the bottom surface is provided in a portion overlapped with the second conductor portion 56 of the groove 26, and the wire 76 is formed as a film to cover the convex portion 261. Accordingly, a portion positioned on the top surface of the convex portion 261 of the wire 76 is in contact with a lower surface of the second conductor portion 56, and the wire 76 and the second conductor portion 56 are electrically connected to each other.

In addition, as illustrated in FIG. 4, the third conductor portion 57 is disposed by being overlapped with the groove 27, and electrically connected to the wire 77 disposed in the groove 27. Specifically, a convex portion 271 protruding from the bottom surface is provided in a portion overlapped with the third conductor portion 57 of the groove 27, and the wire 77 is formed as a film to cover the convex portion 271. Accordingly, a portion positioned on the top surface of the convex portion 271 of the wire 77 is in contact with a lower surface of the third conductor portion 57, and the wire 77 and the third conductor portion 57 are electrically connected to each other.

As described above, without passing through other members, by directly being the wires 75, 76, and 77 in contact with the first, the second, and the third conductor portions 55, 56, and 57, these electrical connections therebetween become favorable. However, an electrical connection method of the wires 75, 76, and 77, and the first, the second, and the third conductor portions 55, 56, and 57, is not particularly limited. For example, conductive bumps may be arranged between the wires 75, 76, and 77, and the first, the second, and the third conductor portions 55, 56, and 57, and the wires 75, 76, and 77, and the first, the second, and the third conductor portions 55, 56, and 57 may be electrically connected to each other via the bump.

Such a conductor portion 5 is configured with the same material as that of the sensor element. In the present embodiment, for example, the conductor portion 5 can be formed by patterning using etching (particularly dry etching) on the conductive silicon substrate doped with impurities such as phosphorus (P), boron (B), arsenic (As), or the like. In addition, the conductor portion 5 is bonded to the upper surface of the substrate 2 by the anodic bonding. Particularly, in the present embodiment, as described in a manufacturing method (which will be described below), by processing a silicon substrate 30 obtained by the anodic bonding on the upper surface of the substrate 2 by the dry etching, the sensor element 3 and the conductor portion 5 are collectively formed from the silicon substrate 30. With this configuration, without increasing the manufacturing processes of the physical quantity sensor 1, it is possible to form the conductor portion 5 on the substrate 2. Although a thickness of the silicon substrate 30 is not particularly limited, it is preferable that the thickness is set as, for example, equal to or greater than 50 μm and equal to or less than 400 μm. With this configuration, it is possible to reduce (low profile) a size of the sensor element 3 and the conductor portion 5 while securing sufficient intensity. In addition, the silicon substrate 30 can be thinned in a bonding process (which will be described below). It is more preferable that the thickness of the silicon substrate 30 is set as equal to or greater than 10 μm and equal to or less than 100 μm.

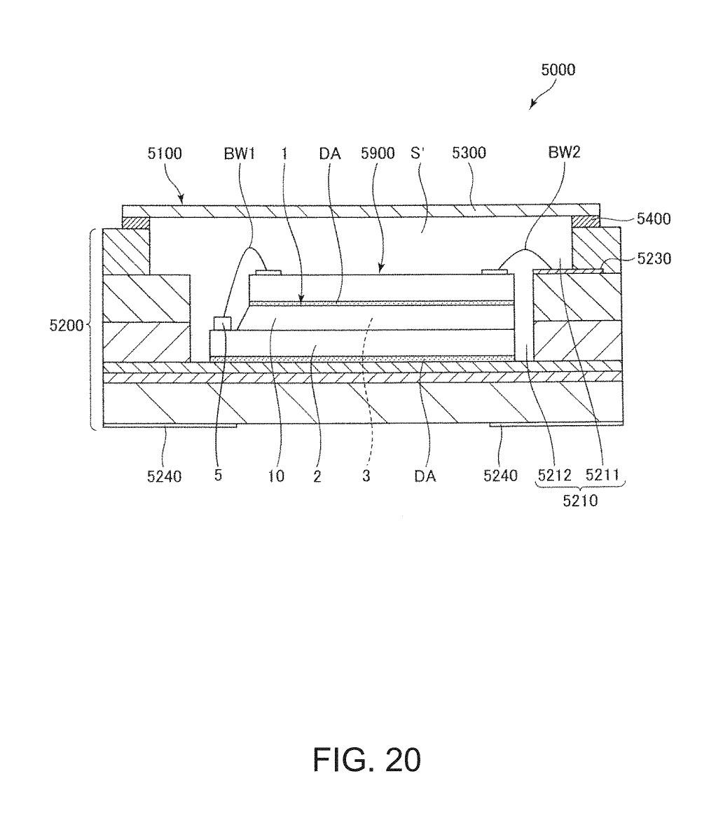

As described above, the first, the second, and the third conductor portions 55, 56, and 57 function as terminals of the physical quantity sensor 1, and are connected to a bonding wire on an upper surface thereof (see FIG. 20 (which will be described below)). With this configuration, as a connection surface of the bonding wire is higher, the lid 10 becomes less obstructive when the bonding wires are connected to the first, the second, and the third conductor portions 55, 56, and 57 (when pressing capillary). Therefore, it is easy to connect the bonding wire to the first, the second, and the third conductor portions 55, 56, and 57.

In the present embodiment, since the first, the second, and the third conductor portions 55, 56, and 57 are configured with silicon, there is a possibility that the connection intensity between the first, the second, and the third conductor portions 55, 56, and 57 and the bonding wire is insufficient. Therefore, it is preferable that a metal film (for example, laminated body of Cr underlayer and Au coating layer) is formed on upper surfaces (connection surfaces) of the first, the second, and the third conductor portions 55, 56, and 57. With this configuration, it is possible to sufficiently increase the connection intensity between the first, the second, and the third conductor portions 55, 56, and 57, and the bonding wire.

In the present embodiment, since the first, the second, and the third conductor portions 55, 56, and 57, and the sensor element 3 are formed from the silicon substrate 30, upper surfaces of the first, the second, and the third conductor portions 55, 56, and 57, and an upper surface of the sensor element 3 are positioned on the same surface. That is, the upper surfaces of the first, the second, and the third conductor portions 55, 56, and 57, and the upper surface of the sensor element 3 are on the same surface. Therefore, it is possible to know the height of the sensor element 3 which cannot be visually observed by being covered with the lid 10 from the heights of the first, the second, and the third conductor portions 55, 56, and 57.

Here, as illustrated in FIG. 1, each of the gap G1 between the first conductor portion 55 and the second conductor portion 56 which are adjacent to each other, and the gap G2 between the first conductor portion 55 and the third conductor portion 57 which are adjacent to each other, is smaller than a minimum gap Gmin in the sensor element 3. That is, a relationship between G1<Gmin and G2<Gmin is satisfied. The minimum gap Gmin means the separated distance between portions arranged closest to each other among respective portions included in the sensor element 3. In the present embodiment, a gap G3 between the moving electrode finger 36 and the first fixed electrode finger 37, and a gap G4 between the moving electrode finger 36 and the second fixed electrode finger 38 are the minimum gap Gmin.

However, a location at which the minimum gap Gmin is obtained, is not particularly limited, and is changed according to a shape of the sensor element 3. For example, if it is a shape illustrated in FIG. 5, a gap G5 between the moving portion 33 and each first fixed electrode finger 37, and a gap G6 between the moving portion 33 and each second fixed electrode finger 38 are the minimum gap Gmin, and if it is a shape illustrated in FIG. 6, a gap G7 between arms of the springs 34 and 35 is the minimum gap Gmin.

As described above, by satisfying a relationship between G1<Gmin and G2<Gmin, when the sensor element 3 is formed from the silicon substrate 30, it is possible to suppress distribution of potential and heat within the silicon substrate (preferably, it is possible to uniformly process distribution), and it is possible to reduce the etching unevenness within the silicon substrate 30. Therefore, it is possible to form the sensor element 3 with high processing accuracy such that it is possible to obtain the physical quantity sensor 1 which can detect an acceleration Ax with high accuracy. For the above-described effect, details will be described in the description of a method of manufacturing the physical quantity sensor 1 (which will be described below). The G1 and G2 may be equal to each other or may be different from each other, but it is preferable that they are equal to each other. With this configuration, the design of the conductor portion 5 and the sensor element 3 becomes simple.

In addition, the minimum value of G1 (G2) is not particularly limited, and is changed according to the thickness of the silicon substrate 30. For example, it is preferable that the minimum value is equal to or greater than 0.1 μm and equal to or less than 10 μm, and it is more preferable that the minimum value is equal to or greater than 0.3 μm and equal to or less than 3 μm. With this configuration, it is possible to suppress that an etching rate is remarkably lowered, and it is possible to form the sensor element 3 and the conductor portion 5 without accompanying the excessive increase of a processing time.

So far, a configuration of the physical quantity sensor 1 is described. For example, at the time of operating the physical quantity sensor 1, a voltage V1 in FIG. 7 is applied to the moving structure 3A via the wire 75, and each first fixed electrode finger 37 and each second fixed electrode finger 38 are connected to a QV amplifier (charge voltage conversion circuit) via the wires 76 and 77. Accordingly, an electrostatic capacitance Ca is formed between each first fixed electrode finger 37 and each moving electrode finger 36, and an electrostatic capacitance Cb is formed between each second fixed electrode finger 38 and each moving electrode finger 36.

When the acceleration Ax is applied to the physical quantity sensor 1, based on the magnitude of the acceleration Ax, the moving portion 33 is displaced in the X-axis direction while deforming the springs 34 and 35. According to the displacement, a gap between the first fixed electrode finger 37 and the moving electrode finger 36 and a gap between the second fixed electrode finger 38 and the moving electrode finger 36 are changed such that the electrostatic capacitances Ca and Cb are changed according to the change. Therefore, it is possible to detect the acceleration Ax based on the change of these electrostatic capacitances Ca and Cb.

When the electrostatic capacitance Ca increases, the electrostatic capacitance Cb decreases. On the other hand, when the electrostatic capacitance Ca decreases, the electrostatic capacitance Cb increases. Therefore, by performing differential calculation (subtraction process: Ca−Cb) on a detection signal (signal in accordance with magnitude of electrostatic capacitance Ca) obtained from the wire 76 and a detection signal (signal in accordance with magnitude of electrostatic capacitance Cb) obtained from the wire 77, it is possible to cancel noise and it is possible to more accurately detect the acceleration Ax.

Next, the method of manufacturing a physical quantity sensor 1 will be described. As illustrated in FIG. 8, the method of manufacturing a physical quantity sensor 1 includes a preparation process S1 for preparing the substrate 2, a bonding process S2 for bonding the silicon substrate 30 serving as a base material of the sensor element 3 and the conductor portion 5 on the substrate 2, a dry etching process S3 for forming the sensor element 3 and conductor portion 5 by patterning using the dry etching on the silicon substrate 30, a lid bonding process S4 for bonding the lid 10 on the substrate 2, and a separation process S5. Hereinafter, respective processes will be sequentially described.

### Preparation Process

First, as illustrated in FIG. 9, a glass substrate 20 serving as a base material of the substrate 2 is prepared. A plurality of separated regions K arranged in a matrix shape are included in the glass substrate 20, and the concave portion 21, and the grooves 25, 26, and 27 are formed on each separated region K. Next, in each separated region, the wires 75, 76, and 77 are arranged in the grooves 25, 26, and 27, respectively.

### Bonding Process

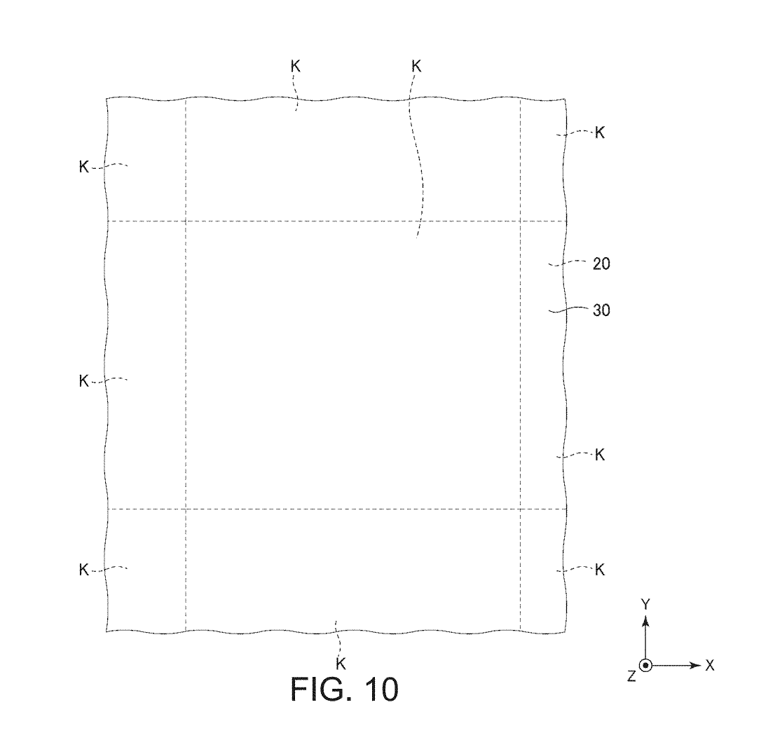

Next, as illustrated in FIG. 10, the silicon substrate 30 (processing target substrate) serving as a base material of the sensor element 3 and the conductor portion 5 is prepared, and the silicon substrate 30 is bonded to an upper surface of the glass substrate 20. A method of bonding the silicon substrate 30 and the glass substrate 20 is not particularly limited. However, in the present embodiment, bonding is performed by an anodic bonding method. Next, after thinning the silicon substrate 30 by using chemical mechanical polishing (CMP) if necessary, conductivity is imparted by doping (diffusing) impurities such as phosphorus (P), boron (B), arsenic (As), or the like into the silicon substrate 30. However, an order of doping the impurities is not particularly limited, the doping may be performed before the thinning of the silicon substrate 30, or may be performed before the bonding of the silicon substrate 30 on the glass substrate 20.

### Dry Etching Process

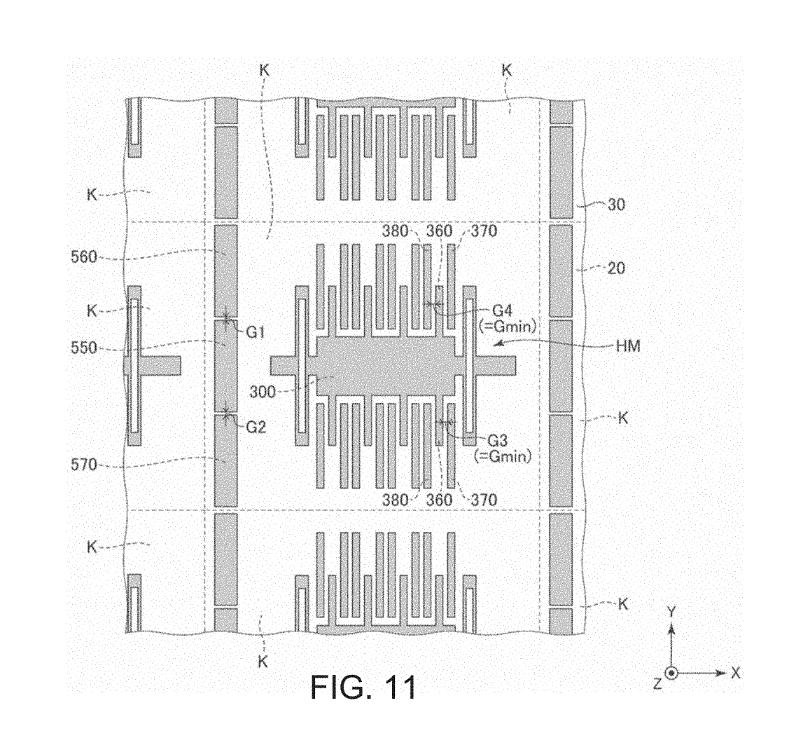

Next, as illustrated in FIG. 11, a hard mask HM having dry etching resistance is formed on an upper surface of the silicon substrate 30. The hard mask HM is formed corresponding to the shapes of the sensor element 3 and the conductor portion 5 for each separated region K. For example, the hard mask HM can be formed by patterning the silicon oxide film formed by thermally oxidizing on a surface of the silicon substrate 30. However, a configuration material and a method of forming the hard mask HM is not particularly limited as long as the function thereof can be exhibited.

Here, in each separated region K, each of the gap G1 (opening width of hard mask HM) between a portion 550 which is for the first conductor portion 55 and a portion 560 which is for the second conductor portion 56, and the gap G2 (opening width of hard mask HM) between the portion 550 which is for the first conductor portion 55 and a portion 570 which is for the third conductor portion 57, is smaller than the minimum gap Gmin (opening width of hard mask HM) in a portion 300 which is for the sensor element 3. That is, the relationship between G1<Gmin and G2<Gmin is satisfied. In the present embodiment, the gap G3 between a portion 360 which is for the moving electrode finger 36 and a portion 370 which for is the first fixed electrode finger 37, and the gap G4 between the portion 360 which is for the moving electrode finger 36 and a portion 380 which is for the second fixed electrode finger 38 are the minimum gap Gmin.

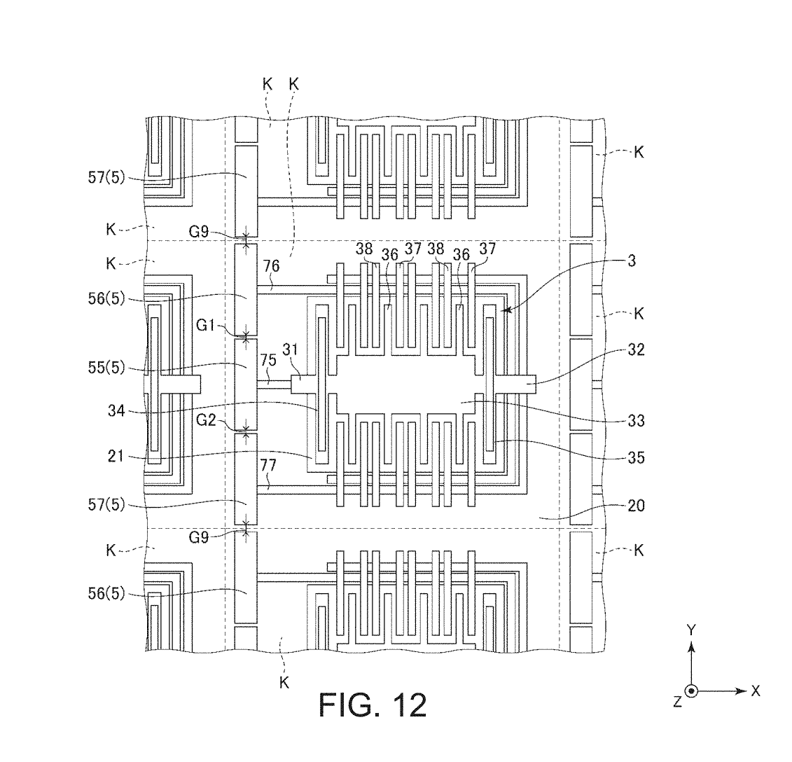

Next, the dry etching is performed on the silicon substrate 30 by using the hard mask HM. With this configuration, as illustrated in FIG. 12, the sensor element 3 and the conductor portion 5 are collectively formed from the silicon substrate 30 for each separated region K. The dry etching method is not particularly limited. However, it is possible to use, for example, a dry Bosch method combining an etching process using reactive plasma gas and a deposition process.

Here, as an opening of the hard mask HM is smaller (as gap of structure body is smaller), the dry etching has the property that the reactive gas hardly intrudes into this portion and the etching rate becomes slow accordingly. As described above, in the present embodiment, since the relationship between G1<Gmin and G2<Gmin is satisfied, a time T1 (time in which first, second, and third conductor portions 55, 56, and 57 are separated from each other) in which the first, the second, and the third conductor portions 55, 56, and 57 are formed from the silicon substrate 30, is later than a time T2 in which the sensor element 3 is formed from the silicon substrate 30. Therefore, as illustrated in FIG. 13 and FIG. 14, it is possible to maintain a state in which, for each separated region K, until the sensor element 3 is formed, the first, the second, and the third conductor portions 55, 56, and 57 are connected by a portion 50 (remaining portion of silicon substrate 30) therebetween without separating from each other and respective portions (particularly, portion to be sensor element 3) of the silicon substrate 30 are electrically connected to each other via the wires 75, 76, and 77. With this configuration, it is possible to evenly maintain charges accumulated in the silicon substrate 30 by an electric field applied thereto during the dry etching for each separated region K. Furthermore, it is also possible to move heat via the wires 75, 76, and 77, and it is also possible to reduce temperature unevenness within the silicon substrate 30, for each separated region K.

In the dry etching, processing speed is changed by the amount of charge within the silicon substrate 30 and temperature of the silicon substrate 30. Therefore, as described above, for each separated region K, temperature unevenness is reduced by uniformly processing the charges within the silicon substrate 30 such that it is possible to more uniformly process respective portions of the silicon substrate 30. As described above, in the present embodiment, since it is possible to reduce the temperature unevenness by uniformly processing the charges within the silicon substrate 30 until the sensor element 3 is formed for each separated region K, it is possible to form each sensor element 3 with superior processing accuracy. Therefore, it is possible to effectively suppress shape deviation from a design of the sensor element 3, and it is possible to obtain the physical quantity sensor 1 which can accurately detect the acceleration Ax.

Here, for example, the time T1 in which the first, the second, and the third conductor portions 55, 56, and 57 are formed from the silicon substrate 30, means a time in which portions of the gaps G1 and G2 pass through from an upper surface to a lower surface. Similarly, for example, the time T2 in which the sensor element 3 is formed from the silicon substrate 30, means a time in which a portion of the minimum gap Gmin passes through from the upper surface to the lower surface.

In addition, the minimum value of G1 (G2) is not particularly limited, and different according to the thickness of the silicon substrate 30. For example, it is preferable that the minimum value is equal to or greater than 0.1 μm and equal to or less than 10 μm, and it is more preferable that the minimum value is equal to or greater than 0.3 μm and equal to or less than 3 μm. With this configuration, it is possible to reduce the remarkable decrease of the etching rate on the silicon substrate 30, and it is possible to form the sensor element 3 and the conductor portion 5 without accompanying the excessive increase of the processing time.

Particularly, in the present embodiment, as illustrated in FIG. 12, in adjacent separated regions K, a gap G9 between the second conductor portion 56 positioned at one of the separated regions K and the third conductor portion 57 positioned at the other one of the separated region K, is also smaller than the minimum gap Gmin. Therefore, in the present embodiment, until the sensor element 3 is formed for each separated region K, it becomes a state where the entirety of the silicon substrate 30 is connected in electrically and thermally via the wires 75, 76, and 77. Therefore, for the entirety of the silicon substrate 30, it is possible to reduce the temperature unevenness by uniformly processing the charges. As a result, a plurality of sensor elements 3 formed for each separated region K are homogeneous with each other such that a plurality of physical quantity sensors 1 having small differences in characteristics can be obtained. Accordingly, it is possible to improve the yield of the physical quantity sensor 1 and it is possible to reduce a manufacturing cost.

### Lid Bonding Process

Next, as illustrated in FIG. 15, a silicon substrate 100 serving as a base material of the lid 10 is prepared, and the silicon substrate 100 is bonded to an upper surface of the glass substrate 20 via the glass frit 19. With this configuration, the plurality of physical quantity sensors 1 integrally formed, are obtained.

### Separation Process

Next, the glass substrate 20 is cut along a scribe line L illustrated in FIG. 15, and separated for each separated region K. With this configuration, as illustrated in FIG. 16, the plurality of separated physical quantity sensor 1 are obtained.

So far, a configuration and the method of manufacturing a physical quantity sensor 1 are described. As described above, such a physical quantity sensor 1 includes the substrate 2, the sensor element 3 disposed on the substrate 2, and the conductor portion 5 disposed on the substrate 2 and made of the same material as that of the sensor element 3. In addition, the sensor element 3 includes the moving structure 3A which can be displaced with respect to the substrate 2, and the first fixed structure 3B fixed on the substrate 2 and separated from the moving structure 3A. In addition, the conductor portion 5 includes the first conductor portion 55 electrically connected to the moving structure 3A, and the second conductor portion 56 disposed by being separated from the first conductor portion 55 and electrically connected to the first fixed structure 3B. Accordingly, the gap G1 (separated distance) between the first conductor portion 55 and the second conductor portion 56 is smaller than the minimum gap Gmin in the sensor element 3. With this configuration, particularly, in a case where the sensor element 3 is formed by the dry etching on the silicon substrate 30, it is possible to suppress the distribution of potential and heat within the silicon substrate 30 (preferably, it is possible to uniformly process distribution), and it is possible to reduce the etching unevenness within the silicon substrate 30. Therefore, it is possible to form the sensor element 3 with high processing accuracy such that it is possible to obtain the physical quantity sensor 1 which can detect the acceleration Ax with high accuracy.

In addition, as described above, the sensor element 3 includes the second fixed structure 3C fixed on the substrate 2, and separated from the moving structure 3A and the first fixed structure 3B. In addition, the conductor portion 5 includes the third conductor portion 57 which is disposed by being separated from the first conductor portion 55 and the second conductor portion 56, and electrically connected to the second fixed structure 3C. Accordingly, the gap G2 (separated distance) between the third conductor portion 57 and a portion closer to the third conductor portion 57 of the first conductor portion 55 and the second conductor portion 56 (in the present embodiment, first conductor portion 55) is smaller than the minimum gap Gmin in the sensor element 3. With this configuration, particularly, in a case where the sensor element 3 is formed by the dry etching on the silicon substrate 30, it is possible to suppress the distribution of potential and heat within the silicon substrate 30 (preferably, it is possible to uniformly process distribution), and it is possible to reduce the etching unevenness within the silicon substrate 30. Therefore, it is possible to form the sensor element 3 with high processing accuracy such that it is possible to obtain the physical quantity sensor 1 which can detect the acceleration Ax with high accuracy.

In addition, as described above, the moving structure 3A includes the moving portion 33 which can be displaced in the X-axis direction (first direction) with respect to the substrate 2 and the moving electrode finger 36 which is provided in the moving portion 33, and formed with the longitudinal shape along the Y-axis direction (second direction) intersecting the X-axis direction. In addition, the first fixed structure 3B includes the first fixed electrode finger 37 which is formed with the longitudinal shape along the Y-axis direction, positioned at the plus side (one side) in the X-axis direction with respect to the moving electrode finger 36, and positioned to oppose the moving electrode finger 36 via a gap. In addition, the second fixed structure 3C includes the second fixed electrode finger 38 which is formed with the longitudinal shape along the Y-axis direction, positioned at the minus side (the other side) in the X-axis direction with respect to the moving electrode finger 36, and positioned to oppose the moving electrode finger 36 via a gap. With this configuration, as the acceleration sensor which can detect the acceleration Ax in the X-axis direction, it is possible to use the physical quantity sensor 1. Therefore, a highly convenient physical quantity sensor 1 is obtained.

In addition, as described above, the physical quantity sensor 1 includes the lid 10 disposed on the substrate 2 to cover the sensor element 3. The conductor portion 5 is positioned outside the lid 10. With this configuration, it is possible to use the conductor portion 5 as a terminal for connecting an external device and the sensor element 3. Therefore, the electrical connection between the external device and the sensor element 3 is facilitated.

In addition, as described above, the upper surface (main surface positioned to oppose substrate 2) of the sensor element 3 and an upper surface (main surface positioned to oppose substrate 2) of the conductor portion 5 are on the same surface. Therefore, it is possible to know the height of the sensor element 3 which cannot be visually observed by being covered with the lid 10 from the height of the conductor portion 5.

In addition, as described above, the physical quantity sensor 1 includes the wire 75 (first wire) which is disposed on the substrate 2 and electrically connects the moving structure 3A and the first conductor portion 55, the wire 76 (second wire) which is disposed on the substrate 2, and electrically connects the first fixed structure 3B and the second conductor portion 56, and the wire 77 (third wire) which is disposed on the substrate 2, and electrically connects the second fixed structure 3C and the third conductor portion 57. With this configuration, it is possible to electrically connect the moving structure 3A and the first conductor portion 55 each other with a simple configuration, it is possible to electrically connect the first fixed structure 3B and the second conductor portion 56 each other with a simple configuration, and it is possible to electrically connect the second fixed structure 3C and the third conductor portion 57 each other with a simple configuration.

In addition, as described above, the wire 75 includes a portion positioned between the substrate 2 and the first conductor portion 55, the wire 76 includes a portion positioned between the substrate 2 and the second conductor portion 56, and the wire 77 includes a portion positioned between the substrate 2 and the third conductor portion 57. With this configuration, the first conductor portion 55 and the wire 75 can be easily in contact with each other, the second conductor portion 56 and the wire 76 can be easily in contact with each other, and the third conductor portion 57 and the wire 77 can be easily in contact with each other. Accordingly, the electrical connection between the first, the second, and the third conductor portions 55, 56, and 57, and the wires 75, 76, and 77 can be more reliably performed.

In addition, as described above, the substrate 2 includes the convex portion 251 (first convex portion) disposed by being overlapped with the first conductor portion 55, the convex portion 261 (second convex portion) disposed by being overlapped with the second conductor portion 56, and the convex portion 271 (third convex portion) disposed by being overlapped with the third conductor portion 57.

Accordingly, the wire 75 is disposed to cover the convex portion 251, and in contact with the first conductor portion 55 in a portion on the convex portion 251, the wire 76 is disposed to cover the convex portion 261, and in contact with the second conductor portion 56 in a portion on the convex portion 261, and the wire 77 is disposed to cover the convex portion 271, and in contact with the third conductor portion 57 in a portion on the convex portion 271. As described above, without passing through other members, by directly being the wires 75, 76, and 77 in contact with the first, the second, and the third conductor portions 55, 56, and 57, these electrical connections therebetween become favorable.

In addition, as described above, the method of manufacturing a physical quantity sensor 1 includes a process of bonding the silicon substrate 30 (processing target substrate) on the substrate 2, and a process of forming the sensor element 3 and the conductor portion 5 from the silicon substrate 30 by etching on the silicon substrate 30. In addition, the sensor element 3 includes the moving structure 3A which can be displaced with respect to the substrate 2, and the first fixed structure 3B which is fixed to the substrate 2, and separated from the moving structure 3A. In addition, the conductor portion 5 includes the first conductor portion 55 electrically connected to the moving structure 3A, and the second conductor portion 56 which is disposed by being separated from the first conductor portion 55, and electrically connected to the first fixed structure 3B. Accordingly, in the process of etching the silicon substrate 30, the time T1 in which the first conductor portion 55 and the second conductor portion 56 are formed is later than the time T2 in which the sensor element 3 is formed. With this configuration, it is possible to suppress the distribution of potential and heat within the silicon substrate 30 (preferably, it is possible to uniformly process distribution), and it is possible to reduce the etching unevenness within the silicon substrate 30. Therefore, it is possible to form the sensor element 3 with high processing accuracy such that it is possible to obtain the physical quantity sensor 1 which can detect the acceleration Ax with high accuracy. Furthermore, as the above-described related art, since it is unnecessary to perform another process such as removal of a conductive film after formation of the sensor element 3, it is possible to suppress the complication of a forming process of the sensor element 3.

In addition, as described above, the gap G1 (separated distance) between the first conductor portion 55 and the second conductor portion 56 is smaller than the minimum gap Gmin in the sensor element 3. With this configuration, the time T1 can be more reliably later than the time T2. Therefore, it is possible to more reliably form the sensor element 3 with high processing accuracy.

### Second Embodiment

Next, a physical quantity sensor according to a second embodiment will be described.

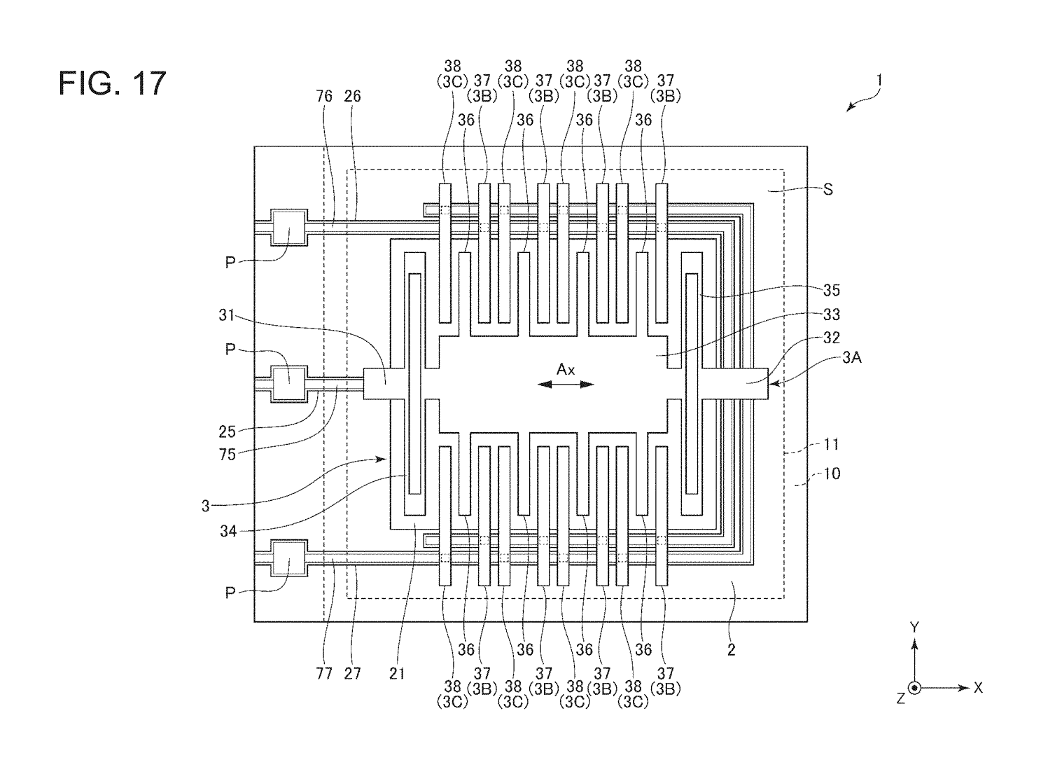

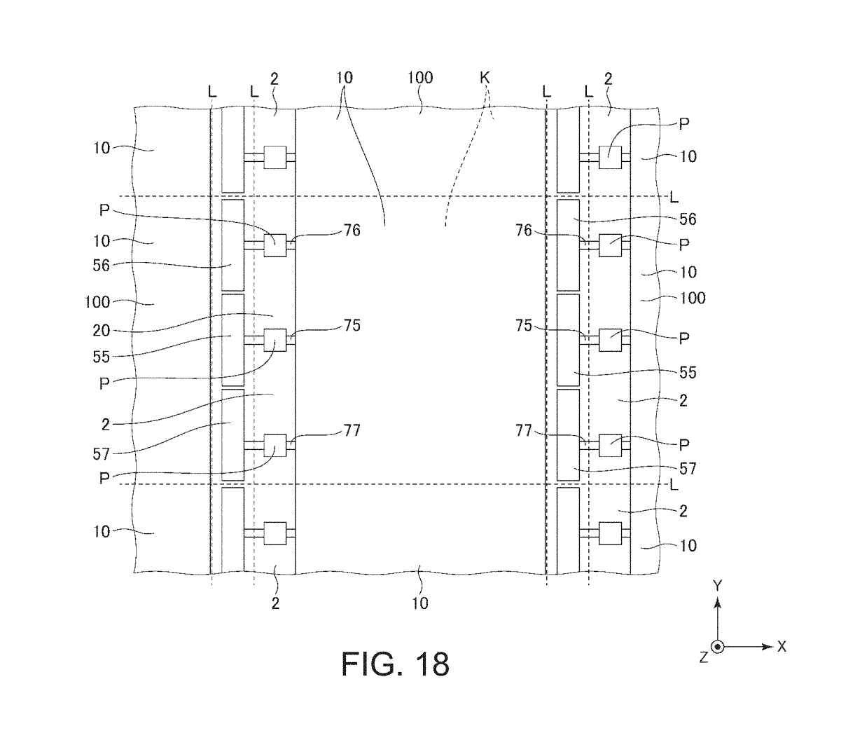

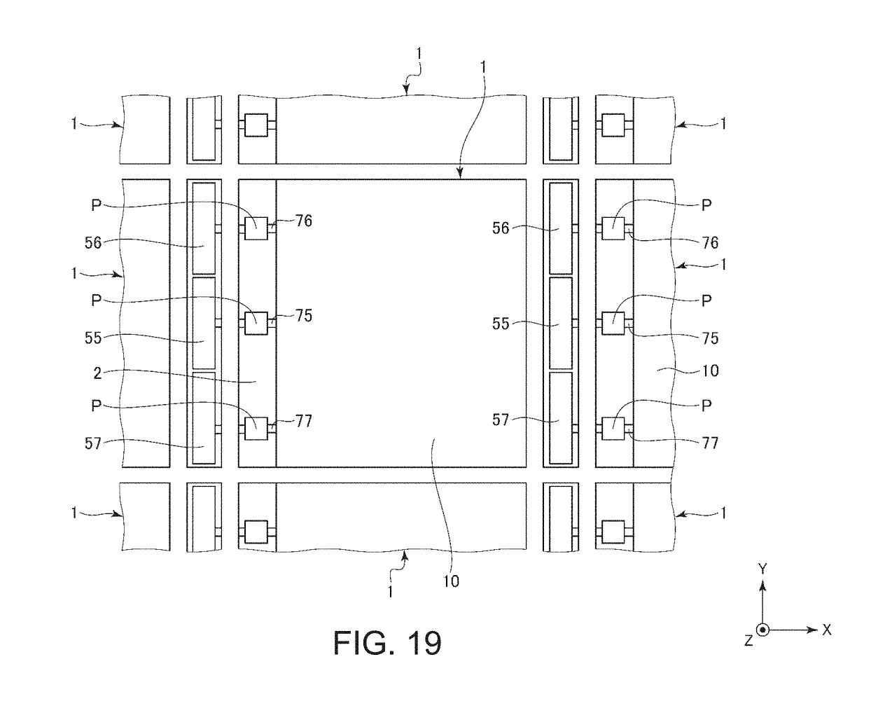

FIG. 17 is a plan view illustrating the physical quantity sensor according to the second embodiment. FIG. 18, and FIG. 19 are plan views for explaining the method of manufacturing a physical quantity sensor illustrated in FIG. 17.

A physical quantity sensor 1 according to the present embodiment is the same as the physical quantity sensor 1 of the above-described first embodiment except that the conductor portion 5 is omitted. In the following description, for the physical quantity sensor 1 of the second embodiment, differences from the above-described first embodiment will be mainly described, and a description relating to the same matter will be omitted. In addition, in FIG. 17 to FIG. 19, the same reference numerals are given to the same configurations as those of the above-described first embodiment.

As illustrated in FIG. 17, in the physical quantity sensor 1 of the present embodiment, the conductor portions 5 (first, second, and third conductor portions 55, 56, and 57) are omitted from the above-described first embodiment. Instead, some of a portion exposed from the lid 10 of the wires 75, 76, and 77 function as a connection pad P. As described above, by omitting the conductor portion 5, it is possible to reduce a size of the physical quantity sensor 1.

Next, a method of manufacturing such physical quantity sensor 1 will be described. The method of manufacturing a physical quantity sensor 1 is the same as that of the above-described first embodiment, and includes the preparation process S1, the bonding process S2, the dry etching process S3, the lid bonding process S4, and the separation process S5. In the manufacturing method of the present embodiment, as compared to the above-described first embodiment, since the separation process S5 is mainly different, the separation process S5 will be described in the following description, and description of other processes will be omitted.

### Separation Process

FIG. 18 illustrates a state in which the lid bonding process S4 is completed. In this state, for each separated region K, the conductor portion 5 is disposed not to be overlapped with the connection pad P. Accordingly, as illustrated in this figure, in the present process, the separation process is performed for each separated region K by cutting the substrate 2 along the scribe line L. With this configuration, the physical quantity sensor 1 is cut between the conductor portion 5 and the connection pad P, and the conductor portion 5 is separated from the physical quantity sensor 1. Therefore, as illustrated in FIG. 19, the physical quantity sensor 1 in which the conductor portion 5 is removed, is obtained. As described above, the method of manufacturing a physical quantity sensor 1 of the present embodiment includes a process which is performed after forming the sensor element 3 and the conductor portion 5, and removes the conductor portion 5. With this configuration, for example, as compared to the above-described first embodiment, it is possible to reduce the size of the physical quantity sensor 1.

By such a second embodiment, it is also possible to exert the same effect as that of the above-described first embodiment.

### Third Embodiment

Next, a physical quantity sensor device according to a third embodiment will be described.

FIG. 20 is a sectional view illustrating the physical quantity sensor device according to the third embodiment.

As illustrated in FIG. 20, a physical quantity sensor device 5000 includes the physical quantity sensor 1, a semiconductor element 5900 (circuit element), and a package 5100 for storing the physical quantity sensor 1 and the semiconductor element 5900. As the physical quantity sensor 1, for example, it is possible to use one of the above-described embodiments.

The package 5100 includes a cavity-shaped base 5200 and a lid 5300 bonded to an upper surface of the base 5200. The base 5200 includes a concave portion 5210 of which an upper surface is open. In addition, the concave portion 5210 includes a first concave portion 5211 which is open at the upper surface of the base 5200 and a second concave portion 5212 which is open at a bottom surface of the first concave portion 5211.

Meanwhile, the lid 5300 has a plate shape and is bonded to the upper surface of the base 5200 to close the opening of the concave portion 5210. By closing the opening of the concave portion 5210 with the lid 5300, the storage space S′ is formed within the package 5100, and the physical quantity sensor 1 and the semiconductor element 5900 are stored in the storage space S′. The method of bonding the base 5200 and the lid 5300 is not particularly limited, and seam welding via a seam ring 5400 is used in the present embodiment.

The storage space S′ is hermetically sealed. The atmosphere of the storage space S′ is not particularly limited. However, it is preferable that it is, for example, the atmosphere the same as that of the storage space S of the physical quantity sensor 1. With this configuration, even if airtightness of the storage space S collapses and the storage spaces S and S′ communicate with each other, it is possible to maintain the atmosphere of the storage space S as it is. Therefore, it is possible to suppress the change of detection characteristics of the physical quantity sensor 1 due to the change of the atmosphere of the storage space S, and it is possible to exert stable detection characteristics.

A configuration material of the base 5200 is not particularly limited, and it is possible to use, for example, various ceramics such as alumina, zirconia, and titania. In addition, although a configuration material of the lid 5300 is not particularly limited, the configuration material may be a member having a coefficient of linear expansion close to that of the configuration material of the base 5200. For example, in a case where the configuration material of the base 5200 is the above-described ceramic, it is preferable that alloy such as Kovar is used.

The base 5200 includes a plurality of internal terminals 5230 arranged within the storage space S′ (bottom surface of first concave portion 5211) and a plurality of external terminals 5240 arranged on the bottom surface. Each internal terminal 5230 is electrically connected to an external terminal 5240 via an internal wire (not illustrated) disposed within the base 5200.

Accordingly, the physical quantity sensor 1 is fixed to the bottom surface of the concave portion 5210 via a die touch material DA, and, furthermore, the semiconductor element 5900 is disposed via the die touch material DA on an upper surface of the physical quantity sensor 1. Accordingly, the physical quantity sensor 1 and the semiconductor element 5900 are electrically connected to each other via a bonding wire BW1, and the semiconductor element 5900 and the internal terminal 5230 are electrically connected to each other via a bonding wire BW2.

In addition, for example, if necessary, a drive circuit for applying a drive voltage to the sensor element 3, a detection circuit for detect the acceleration Ax based on output from the sensor element 3, an output circuit that converts a signal from the detection circuit into a predetermined signal and outputs the predetermined signal, and the like are included in the semiconductor element 5900.

So far, the physical quantity sensor device 5000 is described. Such a physical quantity sensor device 5000 includes the physical quantity sensor 1 and the semiconductor element 5900 (circuit element) electrically connected to the physical quantity sensor 1. Therefore, it is possible to obtain the effect of the physical quantity sensor 1, and it is possible to obtain the physical quantity sensor device 5000 with high reliability.

### Fourth Embodiment

Next, an electronic apparatus according to a fourth embodiment will be described.

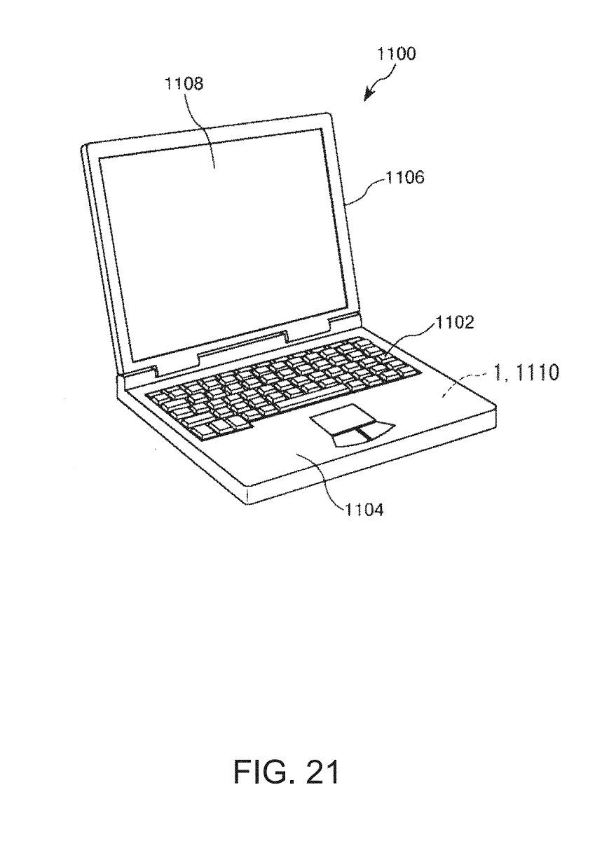

FIG. 21 is a perspective view illustrating the electronic apparatus according to the fourth embodiment.

A mobile type (or notebook type) personal computer 1100 illustrated in FIG. 21 is one to which the electronic apparatus is applied. The personal computer 1100 is configured with a main unit 1104 including a keyboard 1102 and a display unit 1106 including a display 1108, and the display unit 1106 is rotatably supported via a hinge structure with respect to the main unit 1104. In addition, the physical quantity sensor 1 and a control circuit 1110 (control unit) that performs a control process based on the detection signal output from the physical quantity sensor 1 are built in the personal computer 1100. As the physical quantity sensor 1, for example, it is possible to use one of the above-described embodiments.

Such a personal computer 1100 (electronic apparatus) includes the physical quantity sensor 1 and the control circuit 1110 (control unit) that performs the control based on the detection signal output from the physical quantity sensor 1. Therefore, it is possible to obtain the effect of the above-described physical quantity sensor 1, and it is possible to exert high reliability.

### Fifth Embodiment

Next, an electronic apparatus according to a fifth embodiment will be described.

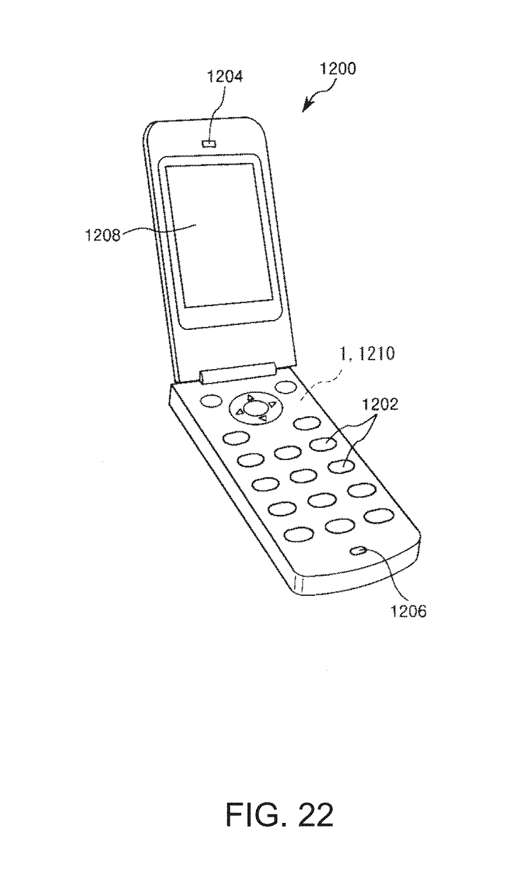

FIG. 22 is a perspective view illustrating the electronic apparatus according to the fifth embodiment.

A mobile phone 1200 (including also PHS) illustrated in FIG. 22 is one to which the present electronic apparatus is applied. The mobile phone 1200 includes an antenna (not illustrated), a plurality of operation buttons 1202, an earpiece 1204, and a mouthpiece 1206, and a display unit 1208 is disposed between the operation button 1202 and the earpiece 1204. In addition, the physical quantity sensor 1 and a control circuit 1210 (control unit) that performs the control operation based on the detection signal output from the physical quantity sensor 1 are built in the mobile phone 1200.

Such a mobile phone 1200 (electronic apparatus) includes the physical quantity sensor 1 and the control circuit 1210 (control unit) that performs the control operation based on the detection signal output from the physical quantity sensor 1. Therefore, it is possible to obtain the effect of the above-described physical quantity sensor 1, and it is possible to exert high reliability.

### Sixth Embodiment

Next, an electronic apparatus according to a sixth embodiment will be described.

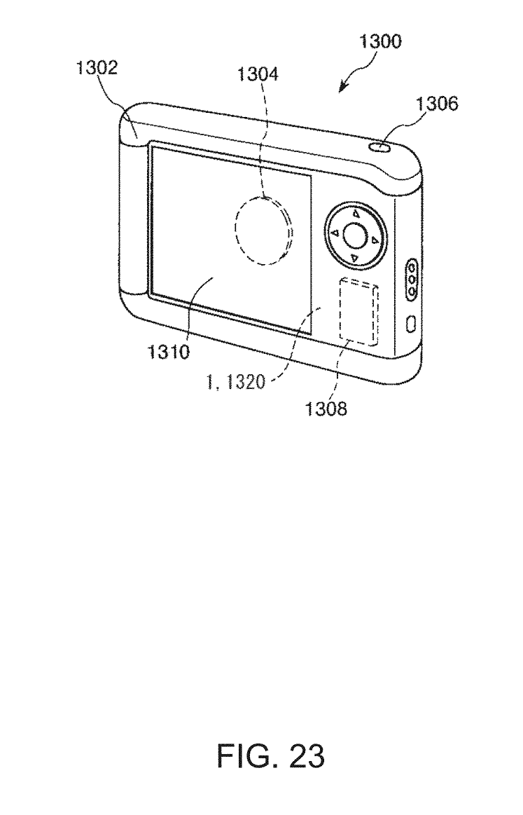

FIG. 23 is a perspective view illustrating the electronic apparatus according to the sixth embodiment.

A digital still camera 1300 illustrated in FIG. 23 is one to which the electronic apparatus is applied. The digital still camera 1300 includes a case 1302, and a display unit 1310 is provided on the back surface of the case 1302. The display unit 1310 is configured to perform a display operation based on an imaging signal by a CCD, and functions as a finder that displays a subject as an electronic image. In addition, a light receiving unit 1304 including an optical lens (image pickup optical system), the CCD, and the like are provided on the front side (back side in drawing) of the case 1302. Accordingly, when a photographer confirms a subject image displayed on the display unit 1310 and presses a shutter button 1306, the imaging signal of the CCD at that time is transferred and stored in a memory 1308. In addition, the physical quantity sensor 1 and a control circuit 1320 (control unit) that performs the control operation based on the detection signal output from the physical quantity sensor 1 are built in the digital still camera 1300. The physical quantity sensor 1 is used, for example, for hand shake correction.

Such a digital still camera 1300 (electronic apparatus) includes the physical quantity sensor 1 and the control circuit 1320 (control unit) that performs the control operation based on the detection signal output from the physical quantity sensor 1. Therefore, it is possible to obtain the effect of the above-described physical quantity sensor 1, and it is possible to exert high reliability.

In addition to the personal computer and the mobile phone of the above-described embodiments, and the digital still camera of the present embodiment, the electronic apparatus can be applied to, for example, a smartphone, a tablet terminal, a clock (including smart watch), an ink jet type discharging device (for example, ink jet printer), a laptop type personal computer, a television, a wearable terminal such as a HMD (head mounted display), a video camera, a video tape recorder, a car navigation device, a pager, an electronic notebook (including communication function), an electronic dictionary, a calculator, an electronic game device, a word processor, a workstation, a video phone, a security monitor for television, an electronic binocular, a POS terminal, medical equipment (electronic clinical thermometer, blood pressure monitor, blood glucose meter, electrocardiogram measuring device, ultrasonic diagnostic device, and electronic endoscope), a fish finder, various measuring instruments, mobile terminal base station equipment, instruments (for example, instruments of vehicle, aircraft, and ship), a flight simulator, a network server, and the like.

### Seventh Embodiment

Next, a vehicle according to a seventh embodiment will be described.

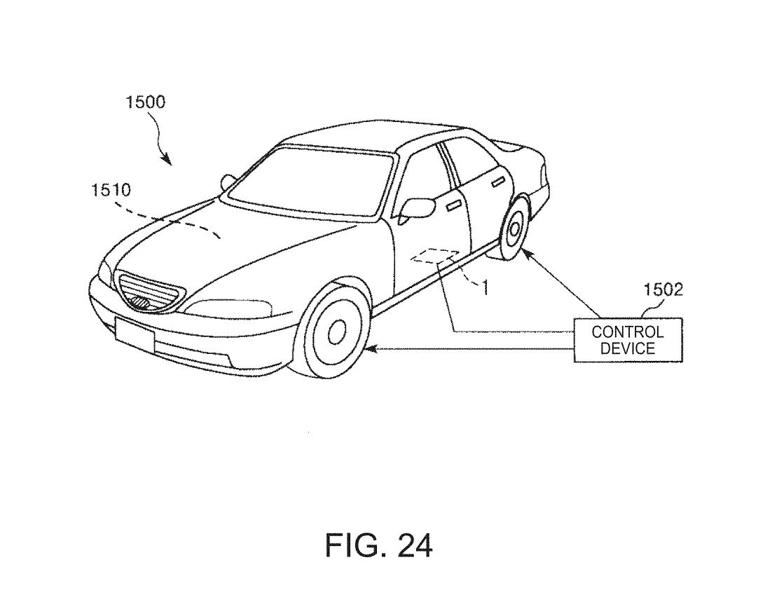

FIG. 24 is a perspective view illustrating the vehicle according to the seventh embodiment.

A car 1500 illustrated in FIG. 24 is a car to which the vehicle is applied. In this figure, the car 1500 includes a system 1510 of at least one of an engine system, a brake system, and a keyless entry system. In addition, the physical quantity sensor 1 is built in the car 1500, the detection signal of the physical quantity sensor 1 is supplied to a control device 1502, and the control device 1502 can control the system 1510 based on a signal thereof.

Such a car 1500 (vehicle) includes the physical quantity sensor 1 and the control circuit 1502 (control unit) that performs the control operation based on the detection signal output from the physical quantity sensor 1. Therefore, it is possible to obtain the effect of the above-described physical quantity sensor 1, and it is possible to exert high reliability.

In addition, the physical quantity sensor 1 can be widely applied to an electronic control unit (ECU) such as a car navigation system, a car air conditioner, an anti-lock braking system (ABS), an airbag, a tire pressure monitoring system (TPMS), an engine control, and a battery monitor of a hybrid car and an electric car.

In addition, the vehicle is not limited to the car 1500, and can also be applied to, for example, an airplane, a rocket, an artificial satellite, a ship, an automatic guided vehicle (AGV), a biped walking robot, and unmanned airplanes such as a drone.

So far, the physical quantity sensor, the method of manufacturing a physical quantity sensor, the physical quantity sensor device, the electronic apparatus, and the vehicle are described based on the illustrated embodiments. However, the invention is not limited thereto and the configuration of each portion can be replaced with an arbitrary configuration having the same function. In addition, any other components may be added to the invention. In addition, the above-described embodiments may be appropriately combined.

In addition, in the above-described embodiment, a configuration is described in which the physical quantity sensor detects the acceleration in the X-axis direction. However, the embodiment is not limited thereto, may be a configuration in which the acceleration in the Y-axis direction is detected, and may be a configuration in which the acceleration in the Z-axis direction is detected. In addition, in the above-described embodiments, a configuration is described in which the physical quantity sensor detects the acceleration. However, the physical quantity detected by the physical quantity sensor is not particularly limited, and may be, for example, angular velocity. In addition, the physical quantity sensor may detect a plurality of physical quantities. The plurality of physical quantities may be physical quantities (for example, acceleration in X-axis direction, acceleration in the Y-axis direction, acceleration in Z-axis direction, angular velocity about X-axis, angular velocity about Y-axis, and angular velocity about Z-axis) of the same kind with different detection axes, and may be different physical quantities (for example, angular velocity about X-axis and acceleration in X-axis direction).

What is claimed is:

1. A physical quantity sensor comprising:
a substrate;
a sensor element disposed on the substrate; and
a conductor portion disposed on the substrate, and formed with the same material as that of the sensor element,
wherein the sensor element includes
a moving structure that can be displaced with respect to the substrate, and a first fixed structure fixed on the substrate, and separated from the moving structure,
the conductor portion includes
a first conductor portion electrically connected to the moving structure, and
a second conductor portion disposed by being separated from the first conductor portion, and electrically connected to the first fixed structure, and
separated distance between the first conductor portion and the second conductor portion is smaller than a minimum gap in the sensor element.

2. The physical quantity sensor according to claim 1,
wherein the sensor element includes a second fixed structure fixed on the substrate, and separated from the moving structure and the first fixed structure,
the conductor portion includes a third conductor portion disposed by being separated from the first conductor portion and the second conductor portion, and electrically connected to the second fixed structure, and
separated distance between the third conductor portion and a portion closer to the third conductor portion in the first conductor portion and the second conductor portion is smaller than the minimum gap in the sensor element.

3. The physical quantity sensor according to claim 2,
wherein the moving structure includes
a moving portion that can be displaced in a first direction with respect to the substrate, and
a moving electrode finger provided on the moving portion, and formed with a longitudinal shape along a second direction intersecting the first direction,
the first fixed structure includes a first fixed electrode finger formed with the longitudinal shape along the second direction, positioned at one side in the first direction with respect to the moving electrode finger, and positioned to oppose the moving electrode finger via a gap, and
the second fixed structure includes a second fixed electrode finger formed with the longitudinal shape along the second direction, positioned at the other side in the first direction with respect to the moving electrode finger, and positioned to oppose the moving electrode finger via a gap.

4. The physical quantity sensor according to claim 1, further comprising:
a lid disposed on the substrate so as to cover the sensor element,
wherein the conductor portion is positioned outside the lid.

5. The physical quantity sensor according to claim 4,
wherein a main surface positioned to oppose the substrate of the sensor element and a main surface positioned to oppose the substrate of the conductor portion are positioned on the same surface.

6. The physical quantity sensor according to claim 1, further comprising:
a first wire disposed on the substrate, and electrically connects the moving structure and the first conductor portion, and
a second wire disposed on the substrate, and electrically connects the first fixed structure and the second conductor portion.

7. The physical quantity sensor according to claim 6,
wherein the first wire includes a portion positioned between the substrate and the first conductor portion, and
the second wire includes a portion positioned between the substrate and the second conductor portion.

8. The physical quantity sensor according to claim 7,
wherein the substrate includes
a first convex portion disposed by being overlapped with the first conductor portion, and
a second convex portion disposed by being overlapped with the second conductor portion,
the first wire is disposed by covering the first convex portion and in contact with the first conductor portion at a portion on the first convex portion, and
the second wire is disposed by covering the second convex portion and in contact with the second conductor portion at a portion on the second convex portion.

9. A method of manufacturing a physical quantity sensor, comprising:
bonding a processing target substrate on a substrate; and
etching the processing target substrate to forma sensor element and a conductor portion from the processing target substrate,
wherein the sensor element includes
a moving structure that can be displaced with respect to the substrate, and
a first fixed structure fixed on the substrate, and separated from the moving structure,
the conductor portion includes
a first conductor portion electrically connected to the moving structure, and
a second conductor portion disposed by being separated from the first conductor portion, and electrically connected to the first fixed structure, and
in the etching, a time in which the first conductor portion and the second conductor portion are formed is later than a time in which the sensor element is formed.

10. The method of manufacturing a physical quantity sensor according to claim 9,
wherein separated distance between the first conductor portion and the second conductor portion is smaller than a minimum gap in the sensor element.

11. The method of manufacturing a physical quantity sensor according to claim 9, further comprising:
removing the conductor portion after formation of the sensor element and the conductor portion.

12. A physical quantity sensor device comprising:
the physical quantity sensor according to claim 1; and
a circuit element electrically connected to the physical quantity sensor.

13. A physical quantity sensor device comprising:
the physical quantity sensor according to claim 2; and
a circuit element electrically connected to the physical quantity sensor.

14. A physical quantity sensor device comprising:
the physical quantity sensor according to claim 3; and
a circuit element electrically connected to the physical quantity sensor.

15. An electronic apparatus comprising:
the physical quantity sensor according to claim 1; and
a control unit that performs a control process based on a detection signal output from the physical quantity sensor.

16. An electronic apparatus comprising:
the physical quantity sensor according to claim 2; and
a control unit that performs a control process based on a detection signal output from the physical quantity sensor.

17. An electronic apparatus comprising:
the physical quantity sensor according to claim 3; and
a control unit that performs a control process based on a detection signal output from the physical quantity sensor.

18. A vehicle comprising:
the physical quantity sensor according to claim 1; and
a control unit that performs a control process based on a detection signal output from the physical quantity sensor.

19. A vehicle comprising:
the physical quantity sensor according to claim 2; and
a control unit that performs a control process based on a detection signal output from the physical quantity sensor.

20. A vehicle comprising:
the physical quantity sensor according to claim 3; and
a control unit that performs a control process based on a detection signal output from the physical quantity sensor.
